(19) United States
(12) Patent Application Publication
(10) Pub. No.: US 2018/0088698 A1
(43) Pub. Date: Mar. 29, 2018

(54) ELECTRONIC DEVICE AND DRIVE CONTROLLING METHOD

(71) Applicant: FUJITSU LIMITED, Kawasaki-shi (JP)

(72) Inventors: Tatsuya SUZUKI, Setagaya (JP); Yuichi KAMATA, Isehara (JP)

(73) Assignee: FUJITSU LIMITED, Kawasaki-shi (JP)

(21) Appl. No.: 15/828,056

(22) Filed: Nov. 30, 2017

Related U.S. Application Data
(63) Continuation of application No. PCT/JP2015/068370, filed on Jun. 25, 2015.

(51) Int. Cl. G06F 3/043; G06F 3/042; G06F 3/041; G06F 3/0488

(52) U.S. Cl. CPC G06F 3/043; G06F 3/0425; G06F 3/044; G06F 3/0488; G06F 3/0412; G06F 3/0416

(57) ABSTRACT

An electronic device includes an imaging part configured to acquire an image and a range image in a field of view that includes a photographic subject, a range image extracting part configured to extract a range image of the photographic subject based on the image and the range image, a gloss determining part configured to determine whether the photographic subject is a glossy object based on a data lacking portion included in the range image of the photographic subject, a display part configured to display the image, a top panel, a position detector configured to detect a position of a manipulation input, a vibrating element configured to be driven by a driving signal, an amplitude data allocating part configured to allocate first amplitude and second amplitude, and a drive controlling part configured to drive the vibrating element by using the driving signal.

### CROSS-REFERENCE TO RELATED APPLICATIONS

This application is a continuation application of International Application PCT/JP2015/068370 filed on Jun. 25, 2015 and designated the U.S., the entire contents of which are incorporated herein by reference.

### FIELD

The disclosures herein relate to an electronic device and a drive controlling method.

### BACKGROUND

Conventionally, there exists a method for automatically determining and providing a tactile sensation of a shape of an object, such as projections and recesses, based on the gradient of a photographic subject that is traced by a user's finger. Such a method uses a range image having three-dimensional information about the photographic subject.

However, the conventional method for automatically determining and providing a tactile sensation can only provide a tactile sensation of a shape of an object and cannot provide a tactile sensation based on the presence or absence of gloss. [Non-Patent Document] Kim, Seung-Chan, Ali Israr, and Ivan Poupyrev. “Tactile rendering of 3D features on touch surfaces.” Proceedings of the 26th annual ACM symposium on User interface software and technology. ACM, 2013.

### SUMMARY

According to an aspect of the embodiment, an electronic device includes an imaging part configured to acquire an image and a range image in a field of view that includes a photographic subject; a range image extracting part configured to extract a range image of the photographic subject based on the image and the range image; a gloss determining part configured to determine whether the photographic subject is a glossy object based on a data lacking portion included in the range image of the photographic subject; a display part configured to display the image; a top panel disposed on a display surface side of the display part and having a manipulation surface; a position detector configured to detect a position of a manipulation input performed on the manipulation surface; a vibrating element configured to be driven by a driving signal for generating a natural vibration in an ultrasound frequency band on the manipulation surface so as to generate the natural vibration in the ultrasound frequency band on the manipulation surface; an amplitude data allocating part configured to allocate, as amplitude data of the driving signal, first amplitude to a display region of the photographic subject that has been determined to be the glossy object by the gloss determining part, and to allocate, as the amplitude data of the driving signal, second amplitude that is smaller than the first amplitude to the display region of the photographic subject that has been determined to be a non-glossy object by the gloss determining part; and a drive controlling part configured to drive the vibrating element by using the driving signal to which the first amplitude has been allocated in accordance with a degree of time change of the position of the manipulation input, upon the manipulation input onto the manipulation surface being performed in a region where the photographic subject that has been determined to be the glossy object by the gloss determining part is displayed on the display part, and to drive the vibrating element by using the driving signal to which the second amplitude has been allocated in accordance with the degree of time change of the manipulation input, upon the manipulation input onto the manipulation surface being performed in the region where the photographic subject that has been determined to be the non-glossy object by the gloss determining part is displayed on the display part.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a perspective view illustrating an electronic device of a first embodiment;

FIG. 2 is a plan view illustrating the electronic device of the first embodiment;

FIG. 3 is a cross-sectional view of the electronic device taken along line A-A of FIG. 2;

FIG. 4 is a bottom view illustrating the electronic device of the first embodiment.

FIGS. 5A and 5B are drawings illustrating crests of a standing wave formed in parallel with a short side of a top panel, of standing waves generated on the top panel by a natural vibration in an ultrasound frequency band;

FIGS. 6A and 6B are drawings illustrating cases in which a kinetic friction force applied to a user's fingertip performing a manipulation input changes by the natural vibration in the ultrasound frequency band generated on the top panel of the electronic device;

FIG. 7 is a drawing illustrating a configuration of the electronic device according to the first embodiment;

FIG. 8 is a drawing illustrating an example of use of the electronic device;

FIG. 9 is a drawing illustrating a range image acquired by an infrared camera;

FIG. 10 is a drawing illustrating a range image acquired by an infrared camera;

FIG. 11 is a drawing illustrating a range image including noise;

FIG. 12 is a flowchart illustrating processing for allocating amplitude data executed by the electronic device of the first embodiment;

FIG. 13 is a flowchart illustrating processing for allocating amplitude data executed by the electronic device of the first embodiment;

FIG. 14 is a flowchart illustrating in detail a part of the flow illustrated in FIG. 12;

FIGS. 15A through 15D are drawings illustrating image processing that is performed according to the flow illustrated in FIG. 14;

FIG. 16 is a flowchart illustrating processing for acquiring a ratio of noise;

FIG. 17 is a drawing illustrating the amplitude data allocated by an amplitude data allocating part to a specific region;

FIG. 18 is a drawing illustrating amplitude data for a glossy object and amplitude data for a non-glossy object stored in a memory;

FIG. 19 is a drawing illustrating data stored in the memory;

FIG. 20 is a flowchart illustrating processing executed by a drive controlling part of the electronic device of the embodiment;

FIG. 21 is a drawing illustrating an example of an operation of the electronic device of the first embodiment;

FIG. 22 is a drawing illustrating a use scene of the electronic device;

FIG. 23 is a flowchart illustrating processing for allocating amplitude data executed by an electronic device of a second embodiment;

FIG. 24 is a drawing illustrating a probability distribution of a ratio of noise;

FIG. 25 is a drawing illustrating a method for determining a threshold by using a mode method;

FIG. 26 is a flowchart illustrating a method for acquiring an image of a specific region according to a third embodiment;

FIGS. 27A through 27D are drawings illustrating image processing performed according to the flow illustrated in FIG. 26; and

FIG. 28 is a side view illustrating an electronic device of a fourth embodiment.

### DESCRIPTION OF EMBODIMENTS

In the following, embodiments of the present invention will be described with reference to the accompanying drawings.

Hereinafter, embodiments to which an electronic device and a drive controlling method of the present invention are applied will be described.

### First Embodiment

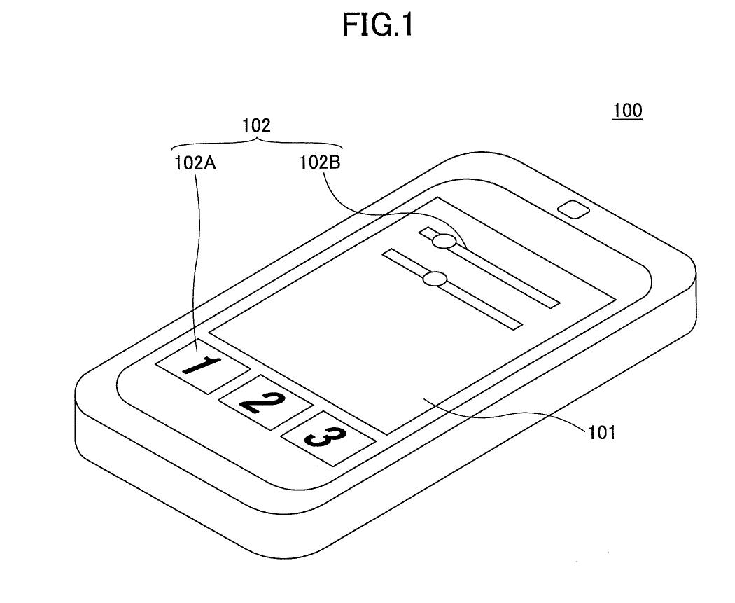

FIG. 1 is a perspective view illustrating an electronic device 100 of a first embodiment.

For example, the electronic device 100 is a smartphone or a tablet computer equipped with a touch panel as a manipulation input part. The electronic device 100 may be any device equipped with a touch panel as a manipulation input part. Therefore, the electronic device 100 may be a device such as a portable information terminal device or an automatic teller machine (ATM) placed at a specific location to be used, for example.

A manipulation input part 101 of the electronic device 100 includes a display panel disposed under a touch panel. Various buttons 102A or sliders 102B in a graphic user interface (GUI) (hereinafter referred to as GUI manipulation parts) are displayed on the display panel.

Typically, the user of the electronic device 100 touches the manipulation input part 101 with the fingertip in order to manipulate GUI manipulation parts 102.

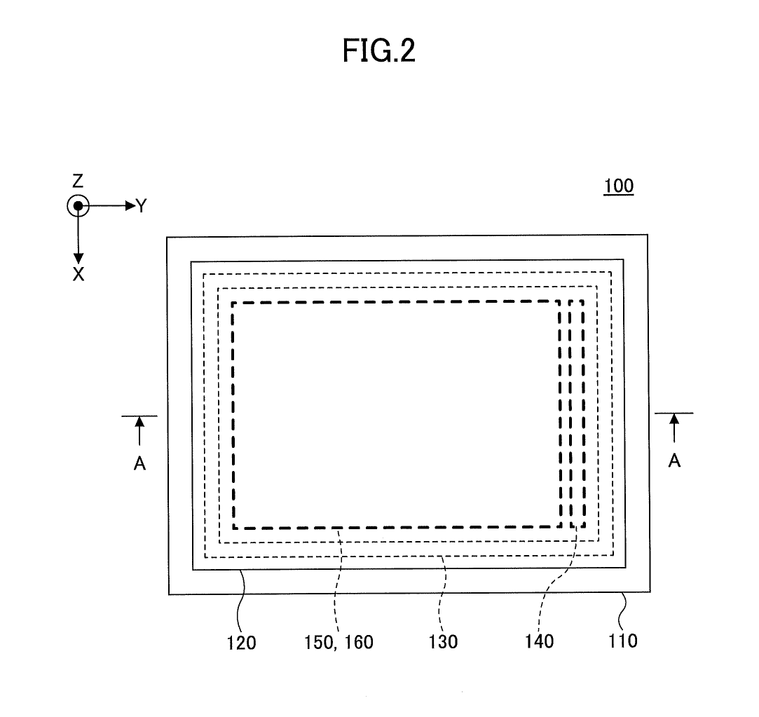

Next, a detailed configuration of the electronic device 100 will be described with reference to FIG. 2.

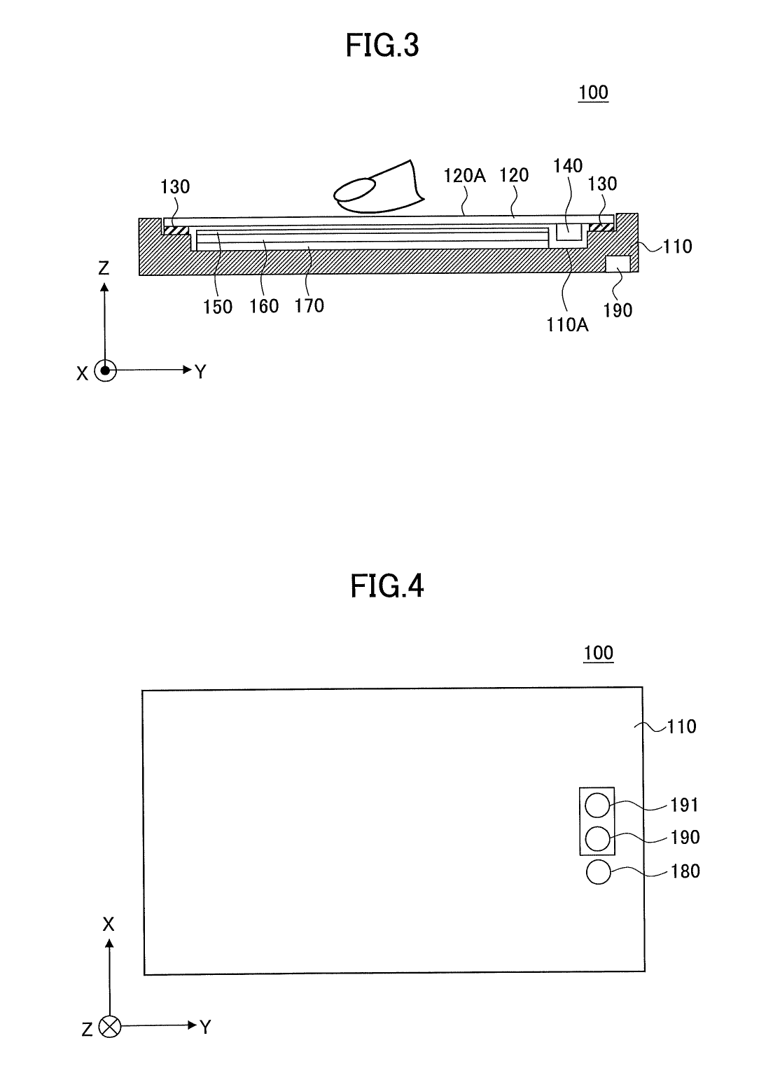

FIG. 2 is a plan view illustrating the electronic device 100 of the first embodiment. FIG. 3 is a cross-sectional view of the electronic device 100 taken along line A-A of FIG. 2. FIG. 4 is a bottom view illustrating the electronic device 100 of the first embodiment. Further, as illustrated in FIGS. 2 through 4, a XYZ coordinate system, which is a rectangular coordinate system, is defined.

The electronic device 100 includes a housing 110, a top panel 120, a double-sided adhesive tape 130, a vibrating element 140, a touch panel 150, a display panel 160, and a substrate 170. In addition, the electronic device 100 includes a camera 180, an infrared camera 190, and an infrared light source 191. The camera 180, the infrared camera 190, and the infrared light source 191 are provided on the bottom of the electronic device 100 (see FIG. 4).

The housing 110 is made of a plastic, for example. As illustrated in FIG. 3, the substrate 170, the display panel 160, and the touch panel 150 are provided in a recessed portion 110A, and the top panel 120 is bonded to the housing 110 with the double-sided adhesive tape 130. The camera 180, the infrared camera 190, and the infrared light source 191 are provided on the bottom of the electronic device 100 (see FIG. 4).

The top panel 120 is a thin, flat member having a rectangular shape when seen in a plan view and made of transparent glass or reinforced plastics such as polycarbonate. A surface 120A (on a positive side in the z-axis direction) of the top panel 120 is an exemplary manipulation surface on which a manipulation input is performed by the user of the electronic device 100.

The vibrating element 140 is bonded to a surface on a negative side in the z-axis direction of the top panel 120. The four sides of the top panel 120 when seen in a plan view are bonded to the housing 110 with the double-sided adhesive tape 130. The double-sided adhesive tape 130 may be any double-sided tape that can bond the four sides of the top panel 120 to the housing 110 and is not necessarily formed in a rectangular ring shape as illustrated in FIG. 3.

The touch panel 150 is disposed on the negative side in the z-axis direction of the top panel 120. The top panel 120 is provided to protect the surface of the touch panel 150. Also, an additional panel, a protective film, and the like may be separately provided on the surface of the top panel 120.

With the vibrating element 140 being bonded to the surface on the negative side in the z-axis direction of the top panel 120, the top panel 120 vibrates when the vibrating element 140 is driven. In the first embodiment, a standing wave is generated on the top panel 120 by vibrating the top panel 120 at the natural vibration frequency. However, in practice, because the vibrating element 140 is bonded to the top panel 120, it is preferable to determine the natural vibration frequency after taking into account the weight and the like of the vibrating element 140.

The vibrating element 140 is bonded to the surface on the negative side in the z-axis direction of the top panel 120, along the short side extending in an x-axis direction, at the positive side in the y-axis direction. The vibrating element 140 may be any element as long as it can generate vibrations in an ultrasound frequency band. For example, the vibrating element 140 may use any element including piezoelectric elements such as a piezoelectric device.

The vibrating element 140 is driven by a driving signal output from the drive controlling part described later. The amplitude (intensity) and frequency of a vibration generated by the vibrating element 140 are set by the driving signal. In addition, an on/off action of the vibrating element 140 is controlled by the driving signal.

The ultrasound frequency band is referred to as a frequency band of approximately 20 kHz or more. In the electronic device 100 of the first embodiment, a frequency at which the vibrating element 140 vibrates is equal to the natural frequency of the top panel 120. Therefore, the vibrating element 140 is driven by the driving signal so as to vibrate at the natural vibration frequency of the top panel 120.

The touch panel 150 is disposed on (the positive side in the z-axis direction of) the display panel 160 and under (the negative side in the z-axis direction of) the top panel 120. The touch panel 150 is illustrated as an example of a position detector that detects a position where the user of the electronic device 100 touches the top panel 120 (hereinafter referred to as a position of a manipulation input).

Various graphic user interface (GUI) buttons and the like (hereinafter referred to as GUI manipulation parts) are displayed on the display panel 160 located under the touch panel 150. Therefore, the user of the electronic device 100 touches the top panel 120 with the fingertip in order to manipulate GUI manipulation parts.

The touch panel 150 may be a position detector that can detect a position of a manipulation input performed by the user on the top panel 120. For example, the touch panel 150 may be a capacitance type or a resistive type position detector. Herein, the embodiment in which the touch panel 150 is a capacitance type position detector will be described. Even if there is a clearance gap between the touch panel 150 and the top panel 120, the touch panel 150 can detect a manipulation input performed on the top panel 120.

Also, in the present embodiment, the top panel 120 is disposed on the input surface side of the touch panel 150. However, the top panel 120 may be integrated into the touch panel 150. In this case, the surface of the touch panel 150 becomes the surface 120A of the top panel 120 as illustrated in FIG. 2 and FIG. 3, and thus becomes the manipulation surface. In addition, the top panel 120 illustrated in FIG. 2 and FIG. 3 may be omitted. The surface of the touch panel 150 becomes the manipulation surface in this case as well. In this case, the panel having the manipulation surface may be vibrated at the natural frequency of that panel.

Furthermore, if the touch panel 150 is a capacitance type touch panel, the touch panel 150 may be disposed on the top panel 120. The surface of the touch panel 150 becomes the manipulation surface in this case as well. If the touch panel 150 is a capacitance type, the top panel 120 illustrated in FIG. 2 and FIG. 3 may be omitted. The surface of the touch panel 150 becomes the manipulation surface in this case as well. In this case, the panel having the manipulation surface may be vibrated at a natural frequency of that panel.

The display panel 160 may be any display part that can display images. The display panel 160 may be a liquid crystal display panel, an organic electroluminescence (EL) panel, or the like, for example. The display panel 160 is placed inside the recessed portion 110A of the housing 110 and placed on (the positive side in the z-axis direction of) the substrate 170 using a holder and the like (not illustrated).

The display panel 160 is driven and controlled by the driver IC 161, which will be described later, and displays GUI manipulation parts, images, characters, symbols, figures, and the like according to the operating condition of the electronic device 100.

Further, a position of a display region of the display panel 160 is associated with coordinates of the touch panel 150. For example, each pixel of the display panel 160 may be associated with coordinates of the touch panel 150.

The substrate 170 is disposed inside the recessed portion 110A of the housing 110. On the substrate 170, the display panel 160 and the touch panel 150 are disposed. The display panel 160 and the touch panel 150 are fixed to the substrate 170 and housing 110 using the holder and the like (not illustrated).

In addition to a drive controlling apparatus, which will be described later, various circuits necessary to drive the electronic device 100 are mounted on the substrate 170.

The camera 180, which is a digital camera configured to acquire a color image, acquires an image in a field of view that includes a photographic subject. The image in the field of view acquired by the camera 180 includes an image of a photographic subject and an image of a background. The camera 180 is an example of a first imaging part. For example, as the digital camera, a camera that has a complementary metal-oxide semiconductor (CMOS) imaging sensor may be used. Further, the camera 180 may be a digital camera for monochrome photography.

The infrared camera 190 acquires a range image in the field of view that includes the photographic subject by irradiating infrared light from the light source 191 onto photographic subject and imaging the reflected light. The range image in the field of view acquired by the infrared camera 190 includes a range image of a photographic subject and a range image of a background.

The infrared camera 190 is a projection-type range image camera. The projection-type range image camera is a camera that projects infrared light and the like onto a photographic subject and reads the infrared light reflected from the photographic subject. A time-of-flight (ToF) range image camera is an example of such a projection-type range image camera. The ToF range image camera is a camera that measures a distance between the ToF range image camera and the photographic subject based on a roundtrip time that the projected infrared light travels. The ToF range image camera includes the infrared camera 190 and the infrared light source 191. The infrared camera 190 and the infrared light source 191 are an example of a second imaging part.

Moreover, the camera 180 and the infrared camera 190 are disposed proximate to each other on the bottom surface of the housing 110. Because image processing is performed by using both an image acquired by the camera 180 and a range image acquired by the infrared camera 190, a size, direction, and the like of an object in the image acquired by the camera 180 can match with those of the range image acquired by the infrared camera by disposing the camera 180 and the infrared camera 190 proximate to each other. Smaller differences in the size and direction between the object of the image acquired by the camera 180 and the object of the range image acquired by the infrared camera 190 make the image processing easier.

The electronic device 100 having the above-described configuration extracts a range image of the photographic subject based on the image in the field of view acquired by the camera 180 and the range image acquired by the infrared camera 190. Subsequently, the electronic device 100 determines whether the photographic subject is a glossy object based on noise included in the range image of the photographic subject. An example of such a glossy object is a metallic ornament. An example of a non-glossy object is a stuffed toy.

The electronic device 100 drives the vibrating element 140 to vibrate the top panel 120 at a frequency in the ultrasound frequency band when the user touches the image of the photographic subject displayed on the display panel 160 and moves the finger along the surface 120A of the top panel 120. The frequency in the ultrasound frequency band is a resonance frequency of a resonance system that includes the top panel 120 and the vibrating element 140. At this frequency, a standing wave is generated on the top panel 120.

At this time, when the photographic subject is a glossy object, the electronic device 100 drives the vibrating element 140 by using a driving signal having larger amplitude, compared to when the photographic subject is a non-glossy object.

Meanwhile, when the photographic subject is a non-glossy object, the electronic device 100 drives the vibrating element 140 by using a driving signal having smaller amplitude, compared to when the photographic subject is a glossy object.

In order to provide a slippery and smooth tactile sensation to the user's fingertip, a driving signal having larger amplitude is used to drive the vibrating element 140 when the photographic subject is a non-glossy object, compared to when the photographic subject is a glossy object.

When the vibrating element 140 is driven by using a driving signal having relatively larger amplitude, a thicker layer of air is present by a squeeze effect between the surface 120A of the top panel 120 and the finger. As a result, a lower kinetic friction coefficient and a tactile sensation of touching the surface of a glossy object can be provided.

In order to provide a soft and gentle tactile sensation to the user's fingertip, a driving signal having smaller amplitude is used to drive the vibrating element 140 when the photographic subject is a non-glossy object, compared to when the photographic subject is a non-glossy object.

When the vibrating element 140 is driven by using a driving signal having relatively smaller amplitude, a thinner layer of air is present by a squeeze effect between the surface 120A of the top panel 120 and the finger. As a result, a higher kinetic friction coefficient and a tactile sensation of touching the surface of a non-glossy object can be provided.

In addition, when the photographic subject is a non-glossy object, the amplitude of a driving signal may be changed in accordance with the elapsed time. For example, when the photographic subject is a stuffed toy, the amplitude of a driving signal may be changed in accordance with the elapsed time so that the user's fingertip can be provided with a tactile sensation of touching a stuffed toy.

Further, the electronic device 100 does not drive the vibrating element 140 when the user touches other regions than the photographic subject image displayed on the display panel 160.

As described above, the electronic device 100 provides, through the top panel 120, the user with the tactile sensation of the photographic subject by changing the amplitude of the driving signal depending on whether the photographic subject is a glossy object.

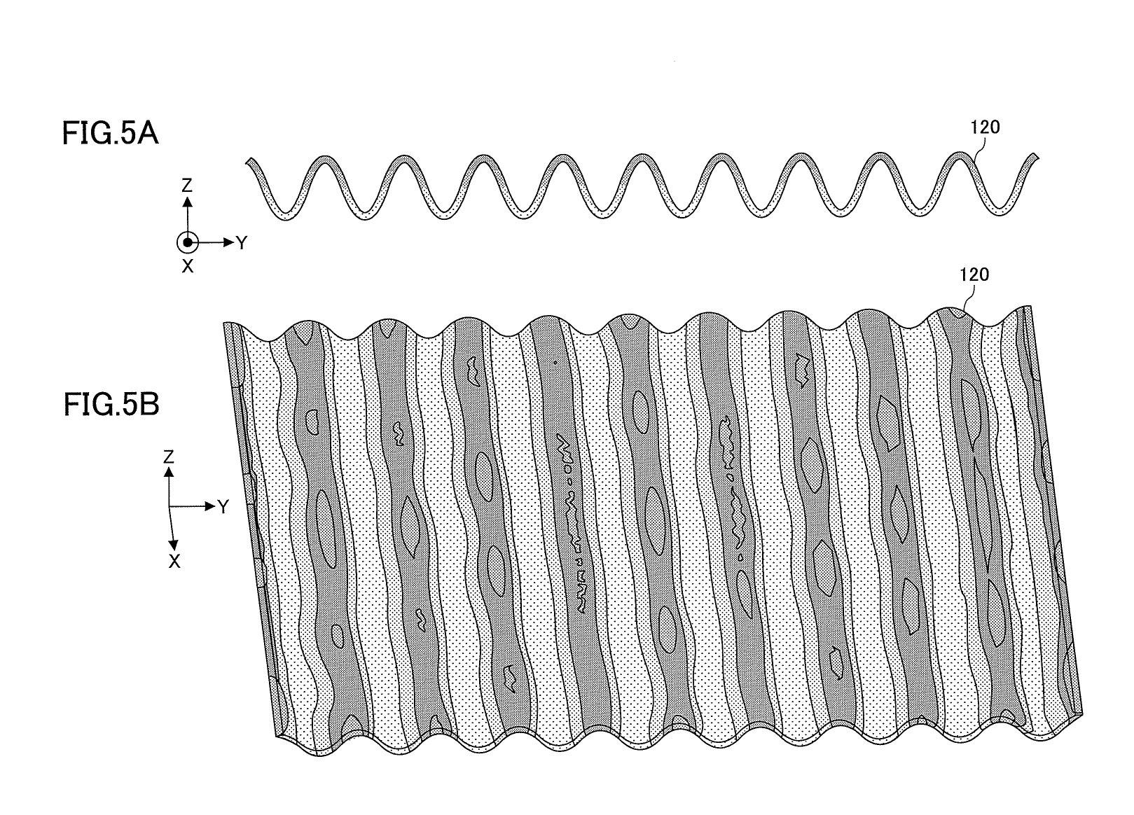

Next, a standing wave generated on the top panel 120 will be described with reference to FIGS. 5A and 5B.

FIGS. 5A and 5B are drawings illustrating crests of a standing wave formed in parallel with a short side of a top panel, of standing waves generated on the top panel by a natural vibration in an ultrasound frequency band. FIG. 5A is a side view and FIG. 5B is a perspective view. In FIGS. 5A and 5B, the same XYZ coordinates as those in FIG. 2 and FIG. 3 are defined. Moreover, to facilitate understanding, the amplitude of the standing wave is exaggeratingly illustrated in FIGS. 5A and 5B. In addition, the vibrating element 140 is omitted in FIGS. 5A and 5B.

The natural vibration frequency (resonance frequency) f of the top panel 120 is expressed by the following formals (1) and (2), where E is the Young's modulus of the top panel 120, ρ is the density of the top panel 120, δ is the Poisson's ratio of the top panel 120, l is the length of a long side of the top panel 120, t is the thickness of the top panel 120, and k is a periodic number of the standing wave generated along the direction of the long side of the top panel 120. Because the standing wave has the same waveforms in every half cycle, the periodic number k takes values at intervals of 0.5 (i.e., 0.5, 1, 1.5, 2, etc.).

$$\begin{matrix}f = \frac{π {k}^{2} t}{{l}^{2}} \sqrt{\frac{E}{3 ρ ( 1 - {δ}^{2} )}} & ( 1 ) \\ f = α {k}^{2} & ( 2 )\end{matrix}$$

It should be noted that the coefficient α included in formula (2) corresponds to the coefficients other than k² included in formula (1).

The waveform of the standing wave in FIGS. 5A and 5B is provided as an example in which the periodic number k is 10. For example, if Gorilla™ glass having the length of a long side 1 of 140 mm, length of a short side of 80 mm, and thickness t of 0.7 mm is used as the top panel 120 and if the periodic number k is 10, the natural vibration frequency f will be 33.5 kHz. In this case, a driving signal whose frequency is 33.5 kHz may be used.

Although the top panel 120 is a flat member, when the vibrating element 140 (see FIG. 2 and FIG. 3) is driven to generate a natural vibration in the ultrasound frequency band, the top panel 120 deflects, and as a result, a standing wave is generated on the surface 120A as illustrated in FIGS. 5A and 5B.

Herein, the embodiment in which the single vibrating element 140 is bonded to the surface on the negative side in the z-axis direction of the top panel 120, along the short side extending in the x-axis direction, at the positive side in the y-axis direction, will be described. However, two vibrating elements 140 may be used. If two vibrating elements 140 are used, the other vibrating element 140 may be bonded to the surface on the negative side in the z-axis direction of the top panel 120, along the short side extending in the x-axis direction, at the negative side in the y-axis direction. In this case, two vibrating elements 140 are axisymmetrically disposed with respect to a centerline parallel to the two short sides of the top panel 120.

In a case where the two vibrating elements 140 are driven, the two vibrating elements 140 may be driven in the same phase if the periodic number k is an integer. If the periodic number k is a decimal (a number containing an integer part and a fractional part), the two vibrating elements 140 may be driven in opposite phases.

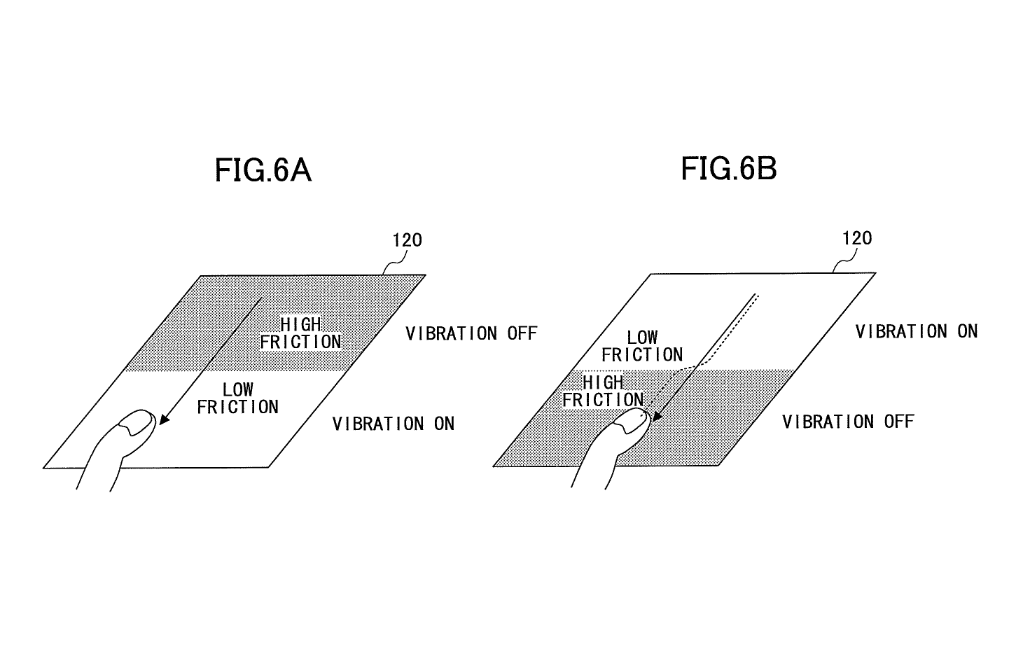

Next, the natural vibration in the ultrasound frequency band generated on the top panel 120 of the electronic device 100 will be described with reference to FIGS. 6A and 6B.

FIGS. 6A and 6B are drawings illustrating cases in which a kinetic friction force applied to a user's fingertip performing a manipulation input changes by the natural vibration in the ultrasound frequency band generated on the top panel of the electronic device. In FIGS. 6A and 6B, while the user touches the top panel 120 with the fingertip, the user performs a manipulation input by moving the finger toward the near side from the far side of the top panel 120 along the direction of an arrow. The vibration can be switched on and off by turning on and off the vibrating element 140. The vibration can be switched on and off by turning on and off the vibrating element 140 (see FIG. 2 and FIG. 3).

In addition, in FIGS. 6A and 6B, when seen in the depth direction, regions that the user's finger touches while the vibration is turned off are represented in gray and regions that the user's finger touches while the vibration is turned on are represented in white.

As can be seen from FIGS. 5A and 5B, the natural vibration in the ultrasound frequency band is generated on the entire top panel 120. However, FIGS. 6A and 6B illustrate operation patterns in which the vibration is switched on and off when the user's finger moves toward the near side from the far side of the top panel 120.

In light of the above, in FIGS. 6A and 6B, when seen in the depth direction, the regions of the top panel 120 that the user's finger touches while the vibration is turned off are represented in gray and the regions of the top panel 120 that the user's finger touches while the vibration is turned on are represented in white.

In the operation pattern illustrated in FIG. 6A, the vibration is turned off when the user's finger is located on the far side of the top panel 120, and the vibration is turned on while the user's finger moves toward the near side.

At this time, when the natural vibration in the ultrasound frequency band is generated on the top panel 120, a layer of air is present by a squeeze effect between the surface 120A of the top panel 120 and the finger. As a result, a kinetic friction coefficient decreases when the user's finger traces the surface 120A of the top panel 120.

Therefore, in FIG. 6A, the kinetic friction force applied to the fingertip increases on the far side of the top panel 120 represented in gray. The kinetic friction force applied to the fingertip decreases on the near side of the top panel 120 represented in white.

Therefore, the user who performs the manipulation input as illustrated in FIG. 6A senses that the kinetic friction force applied to the fingertip is decreased when the vibration is turned on. As a result, the user feels a sense of slipperiness with the finger. In this case, because the surface 120A of the top panel 120 becomes more slippery, the user senses as if a recessed portion exists on the surface 120A of the top panel 120 when the kinetic friction force decreases.

In FIG. 6B, the kinetic friction force applied to the fingertip decreases on the far side of the top panel 120 represented in white. The kinetic friction force applied to the fingertip increases on the near side of the top panel 120 represented in gray.

Therefore, the user who performs the manipulation input as illustrated in FIG. 6B senses that the kinetic friction force applied to the fingertip is increased when the vibration is turned off. As a result, the user feels a sense of non-slipperiness or roughness with the finger. In this case, because the surface 120A of the top panel 120 becomes of higher roughness, the user senses as if a projecting portion exists on the surface of the top panel 120 when the kinetic friction force increase.

As described above, the user can sense projections and recesses with the fingertip in the cases illustrated in FIGS. 6A and 6B. For example, a person's tactile sensation of projections and recesses is disclosed in “The Printed-matter Typecasting Method for Haptic Feel Design and Sticky-band Illusion,” (The collection of papers of the 11th SICE system integration division annual conference (SI2010, Sendai), December 2010, pages 174 to 177). A person's tactile sensation of projections and recesses is also disclosed in “The Fishbone Tactile Illusion” (Collection of papers of the 10th Congress of the Virtual Reality Society of Japan, September, 2005).

Although changes in the kinetic friction force when the vibration is switched on and off have been described above, similar effects can be obtained when the amplitude (intensity) of the vibrating element 140 is changed.

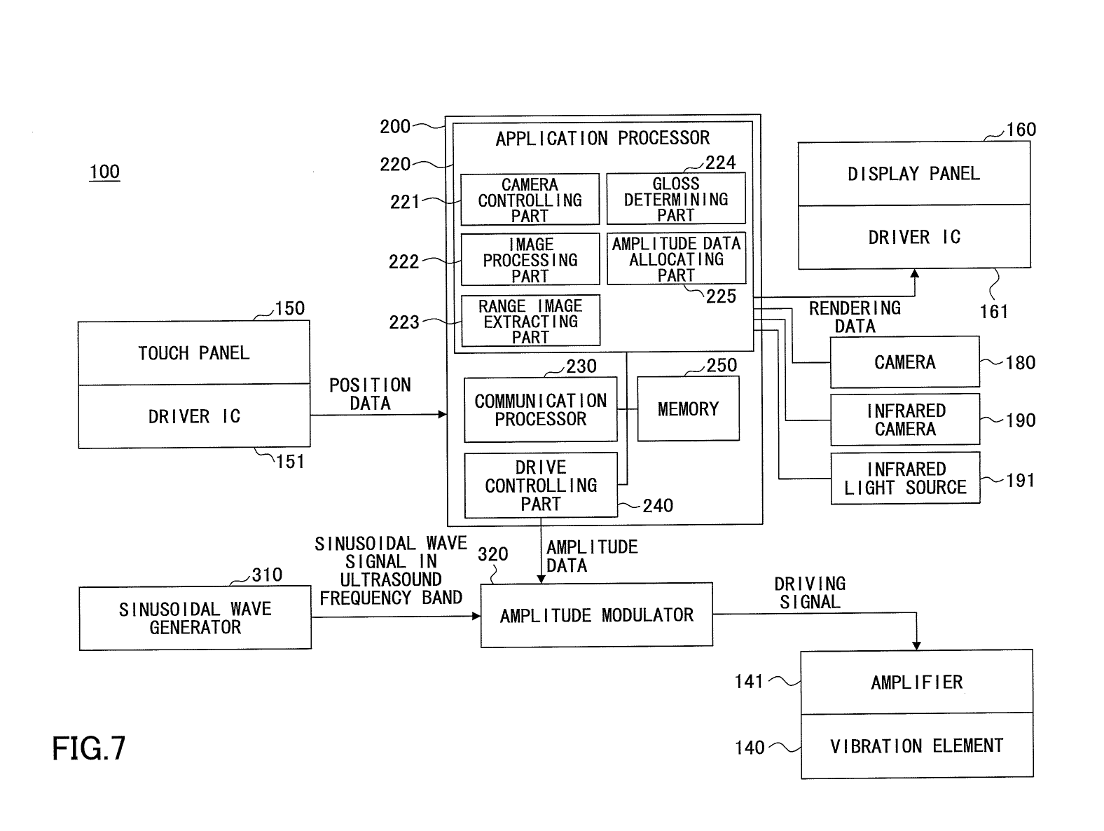

Next, a configuration of the electronic device 100 of the first embodiment will be described with reference to FIG. 7.

FIG. 7 is a drawing illustrating the configuration of the electronic device 100 of the first embodiment.

The electronic device 100 includes the vibrating element 140, an amplifier 141, the touch panel 150, a driver integrated circuit (IC) 151, the display panel 160, a driver IC 161, the camera 180, the infrared camera 190, the infrared light source 191, a controlling part 200, a sinusoidal wave generator 310, and an amplitude modulator 320.

The controlling part 200 includes an application processor 220, a communication processor 230, a drive controlling part 240, and a memory 250. For example, the controlling part 200 is implemented by an IC chip.

The embodiment in which the single controlling part 200 is implemented by the application processor 220, the communication processor 230, the drive controlling part 240, and the memory 250 will be described. However, the drive controlling part 240 may be provided outside the controlling part 200 as a separate IC chip or processor. In this case, of data stored in the memory 250, necessary data for drive control of the drive controlling part 240 may be stored in a separate memory from the memory 250.

In FIG. 7, the housing 110, the top panel 120, the double-sided adhesive tape 130, and the substrate 170 (see FIG. 2) are omitted. Hereinafter, the amplifier 141, a driver IC 151, the driver IC 161, the application processor 220, the drive controlling part 240, the memory 250, the sinusoidal wave generator 310, and the amplitude modulator 320 will be described.

The amplifier 141 is disposed between the amplitude modulator 320 and the vibrating element 140. The amplifier 141 amplifies a driving signal output from the amplitude modulator 320 and drives the vibrating element 140.

The driver IC 151 is coupled to the touch panel 150, detects position data representing the position where a manipulation input is performed on the touch panel 150, and outputs the position data to the controlling part 200. As a result, the position data is input to the application processor 220 and the drive controlling part 240.

The driver IC 161 is coupled to the display panel 160, inputs rendering data output from the application processor 220 to the display panel 160, and displays, on the display panel 160, images based on the rendering data. In this way, GUI manipulation parts, images, or the like based on the rendering data are displayed on the display panel 160.

The application processor 220 performs processes for executing various applications of the electronic device 100. Of the components included in the application processor 220, a camera controlling part 221, an image processing part 222, a range image extracting part 223, a gloss determining part 224, and an amplitude data allocating part 225 are particularly described.

The camera controlling part 221 controls the camera 180, the infrared camera 190, and the infrared light source 191. When a shutter button of the camera 180 displayed on the display panel 160 as a GUI manipulation part is operated, the camera controlling part 221 performs imaging processing by using the camera 180. In addition, when a shutter button of the infrared camera 190 displayed on the display panel 160 as a GUI manipulation part is operated, the camera controlling part 221 causes infrared light to be output from the infrared light source 191 and performs imaging processing by using the infrared camera 190.

Image data representing images acquired by the camera 180 and range image data representing range images acquired by the infrared camera 190 are input to the camera controlling part 221. The camera controlling part 221 outputs the image data and the range image data to the range image extracting part 223.

The image processing part 222 executes image processing other than that executed by the range image extracting part 223 and the gloss determining part 224. The image processing executed by the image processing part 222 will be described later.

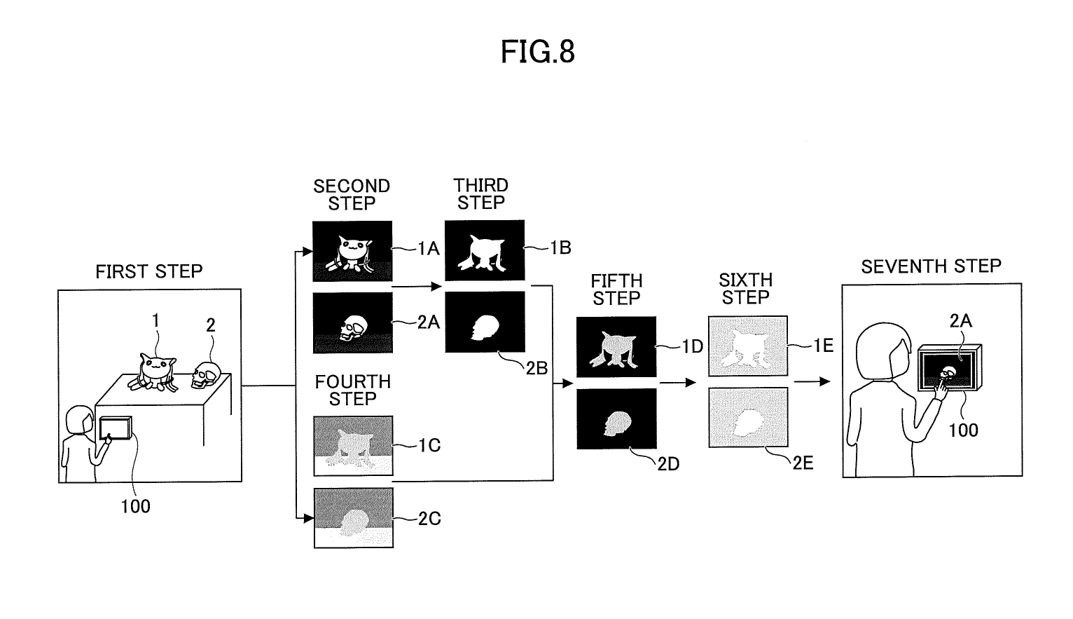

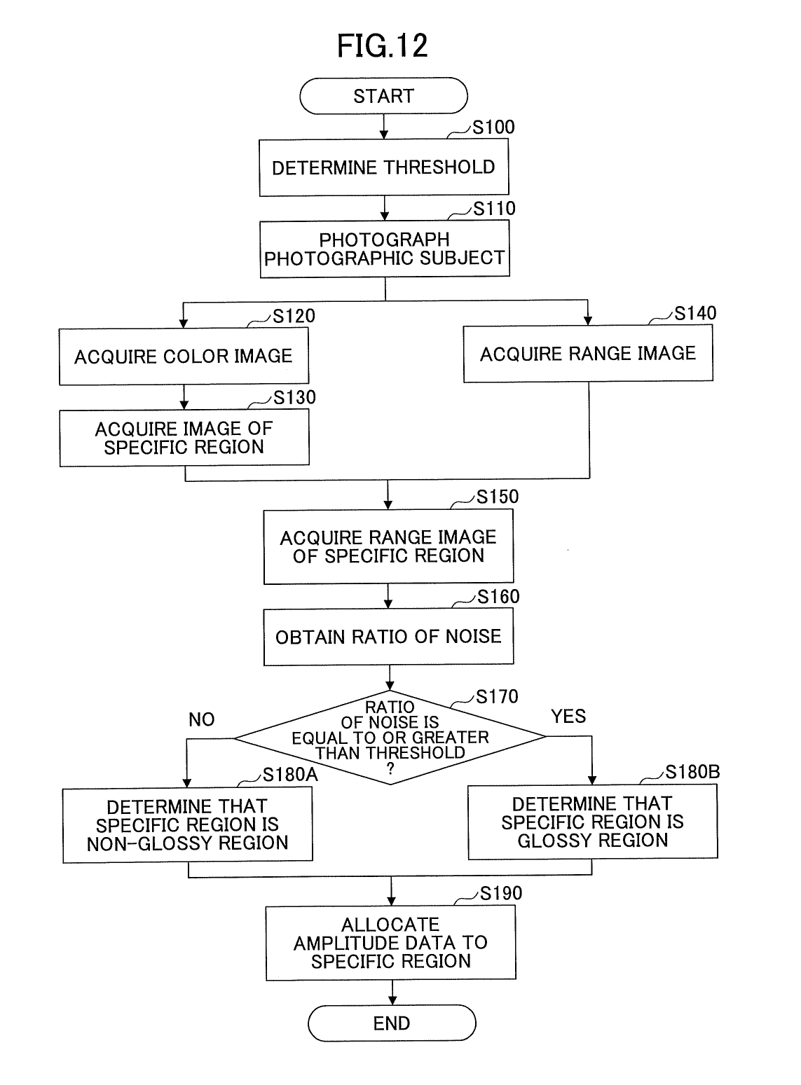

The range image extracting part 223 extracts a range image of a photographic subject based on the image data and the range image data input from the camera controlling part 221. The range image of the photographic subject is data in which each pixel of the image representing the photographic subject is associated with data representing a distance between a lens of the infrared camera 190 and the photographic subject. The processing for extracting a range image of a photographic subject will be described later with reference to FIG. 8 and FIG. 12.

The gloss determining part 224 analyzes noise included in the range image of the photographic subject extracted by the range image extracting part 223. Based on the analysis result, the gloss determining part 224 determines whether the photographic subject is a glossy object. The processing for determining whether the photographic subject is a glossy object based on analysis result of noise will be described with reference to FIG. 12.

The amplitude data allocating part 225 allocates amplitude data of the driving signal of the vibrating element 140 to the image of the photographic subject determined to be the glossy object by the gloss determining part 224 or to the image of the photographic subject determined to be the non-glossy object by the gloss determining part 224. The processing executed by the amplitude data allocating part 225 will be described later with reference to FIG. 12.

The communication processor 230 executes processing necessary for the electronic device 100 to perform third generation (3G), fourth generation (4G), Long-Term Evolution (LTE), and Wi-Fi communications.

The drive controlling part 240 outputs amplitude data to the amplitude modulator 320 when two predetermined conditions are met. The amplitude data is data that represents an amplitude value for adjusting the intensity of driving signals used to drive the vibrating element 140. The amplitude value is set according to the degree of time change of the position data. Herein, the moving speed of the user's fingertip along the surface 120A of the top panel 120 is used as the degree of time change of the position data. The moving speed of the user's fingertip is calculated by the drive controlling part 240 based on the degree of time change of the position data input from the driver IC 151.

The drive controlling part 240 vibrates the top panel 120 in order to change a kinetic friction force applied to the user's fingertip when the fingertip moves along the surface 120A of the top panel 120. Such a kinetic friction force is generated while the fingertip is moving. Therefore, the drive controlling part 240 causes the vibrating element 140 to vibrate when the moving speed becomes equal to or greater than a predetermined threshold speed. The first predetermined condition is that the moving speed is greater than or equal to the predetermined threshold speed.

Accordingly, the amplitude value represented by the amplitude data output from the drive controlling part 240 becomes zero when the moving speed is less than the predetermined threshold speed. The amplitude value is set to a predetermined amplitude value according to the moving speed when the moving speed becomes equal to or greater than the predetermined threshold speed. In a case where the moving speed becomes equal to or greater than the predetermined threshold speed, the higher the moving speed is, the smaller the amplitude value is set, and the lower the moving speed is, the larger the amplitude value is set.

Further, the drive controlling part 240 outputs the amplitude data to the amplitude modulator 320 when the position of the user's fingertip performing a manipulation input is located in a predetermined region where a vibration is to be generated. The second predetermined condition is that the position of the user's fingertip performing a manipulation input is located in a predetermined region where a vibration is to be generated.

Whether or not the position of the fingertip performing a manipulation input is located in a predetermined region where a vibration is to be generated is determined based on whether or not the position of the fingertip performing the manipulation input is located inside the predetermined region. Also, the predetermined region where the vibration is to be generated is a region where a photographic subject, which is specified by the user, is displayed.

A position of a GUI manipulation part displayed on the display panel 160, a position of a region that displays an image, a position of a region representing an entire page, and the like on the display panel 160 are specified by region data representing such regions. The region data exists in all applications for each GUI manipulation part displayed on the display panel 160, for each region that displays an image, and for each region that displays an entire page.

Therefore, a type of an application executed by the electronic device 100 is relevant in determining, as the second predetermined condition, whether the position of the user's fingertip performing a manipulation input is located in a predetermined region where a vibration is to be generated. This is because displayed contents of the display panel 160 differ depending on the type of the application.

This is also because a type of a manipulation input, which is performed by moving the fingertip along the surface 120A of the top panel 120, differs depending on the type of the application. One type of manipulation input performed by moving the fingertip along the surface 120A of the top panel 120 is what is known as a flick operation, which is used to operate GUI manipulation parts, for example. The flick operation is performed by flicking (snapping) the fingertip on the surface 120A of the top panel 120 for a relatively short distance.

When the user turns over pages, a swipe operation is performed, for example. The swipe operation is performed by brushing the fingertip along the surface of the top panel 120 for a relatively long distance. The swipe operation is performed when the user turns over pages or photos, for example. In addition, when the user slides the slider (see a slider 102B in FIG. 1) of a GUI manipulation part, a drag operation is performed to drag the slider.

Manipulation inputs performed by moving the fingertip along the surface 120A of the top panel 120, such as the flick operation, the swipe operation, and the drag operation described above as examples, are selectively used depending on the type of the application. Therefore, a type of an application executed by the electronic device 100 is relevant in determining whether the position of the user's fingertip performing a manipulation input is located in a predetermined region where a vibration is to be generated.

The drive controlling part 240 determines whether the position represented by the position data input from the driver IC 151 is located in a predetermined region where a vibration is to be generated.

As described above, the two predetermined conditions required for the drive controlling part 240 to output amplitude data to the amplitude modulator 320 are that the moving speed of the fingertip is greater than or equal to the predetermined threshold speed and that coordinates of the position of the manipulation input are located in a predetermined region where a vibration is to be generated.

When the position of the manipulation input is located in a region that displays a photographic subject, which is specified by the user, on the display panel 160, and also when the user touches the image of the displayed photographic subject and moves the fingertip along the surface 120A of the top panel 120, the electronic device 100 drives the vibrating element 140 to vibrate the top panel 120 at a frequency in the ultrasound frequency band.

Accordingly, the predetermined region where the vibration is to be generated is a region where the photographic subject specified by the user is displayed on the display panel 160.

When the moving speed of the fingertip is equal to or greater than the predetermined threshold speed and also when the coordinates of the position of the manipulation input are located in the predetermined region where a vibration is to be generated, the drive controlling part 240 reads amplitude data representing an amplitude value and outputs the amplitude data to the amplitude modulator 320.

The memory 250 stores data and programs necessary for the application processor 220 to execute applications and stores data and programs necessary for the communication processor 230 to execute communication processing.

The sinusoidal wave generator 310 generates sinusoidal waves necessary to generate a driving signal for vibrating the top panel 120 at a natural vibration frequency. For example, in order to vibrate the top panel 120 at a natural frequency f of 33.5 kHz, a frequency of the sinusoidal waves becomes 33.5 kHz. The sinusoidal wave generator 310 inputs sinusoidal wave signals in the ultrasound frequency band into the amplitude modulator 320.

The amplitude modulator 320 generates a driving signal by modulating the amplitude of a sinusoidal wave signal input from the sinusoidal wave generator 310 based on amplitude data input from the drive controlling part 240. The amplitude modulator 320 generates a driving signal by modulating only the amplitude of the sinusoidal wave signal in the ultrasound frequency band input from the sinusoidal wave generator 310 without modulating a frequency or a phase of the sinusoidal wave signal.

Therefore, the driving signal output from the amplitude modulator 320 is a sinusoidal wave signal in the ultrasound frequency band obtained by modulating only the amplitude of the sinusoidal wave signal in the ultrasound frequency band input from the sinusoidal wave generator 310. When the amplitude data is zero, the amplitude of the driving signal becomes zero. This is the same as the case in which the amplitude modulator 320 does not output the driving signal.

FIG. 8 is a drawing illustrating an example of use of the electronic device 100.

In a first step, the user takes photographs of a stuffed toy 1 and a metallic ornament 2 by using the camera 180 and the infrared camera 190 of the electronic device 100. More specifically, the user takes a photograph of the stuffed toy 1 by using the camera 180 and takes a photograph of the metallic ornament 2 by using the camera 180. Also, the user takes a photograph of the stuffed toy 1 by using the infrared camera 190 and takes a photograph of the metallic ornament 2 by using the infrared camera 190. The first step is performed by the camera controlling part 221.

The stuffed toy 1 is a stuffed animal character. The stuffed toy 1 is made of non-glossy fabrics and gives the user a fluffy tactile sensation when the user touches the stuffed toy 1 with the finger. The stuffed toy 1 is an example of a non-glossy object.

The metallic ornament 2 is an ornament having a shape of a skull. The metallic ornament has a smooth curved surface and gives the user a slippery tactile sensation when the user touches the metallic ornament 2 with the finger. The metallic ornament 2 is an example of a glossy object.

The glossy object as used herein means that the surface of the object is flat or curved, is smooth to some degree, reflects light to some degree, and provides a slippery tactile sensation to some degree when the user touches the object. Herein, whether an object is glossy or non-glossy is determined by its tactile sensation.

A tactile sensation differs from person to person. Therefore, for example, a boundary (threshold) for determining whether an object is glossy can be set according to the user's preference.

Next, in a second step, an image 1A of the stuffed toy 1 and an image 2A of the metallic ornament 2 are acquired. The image 1A and the image 2A are acquired by separately photographing the stuffed toy 1 and the metallic ornament 2 by the camera 180. The image 1A and the image 2A are displayed on the display panel 160 of the electronic device 100. The second step is performed by the camera controlling part 221 and the image processing part 222.

Next, in a third step, the electronic device 100 performs image processing for the image 1A and the image 2A. Subsequently, the electronic device 100 creates an image 1B and an image 2B. The image 1B and the image 2B represent regions (hereinafter referred to as specific region(s)) that display the photographic subjects (the stuffed toy 1 and the metallic ornament 2) included in the image 1A and the image 2A, respectively.

In the image 1B, a specific region that displays the photographic subject is indicated in white and a background region other than the photographic subject is indicated in black. The region indicated in black is a region where no data exists. The region indicated in white represents pixels of the image of the photographic subject and corresponds to the display region of the stuffed toy 1.

Similarly, in the image 2B, a region that displays the photographic subject is indicated in white and a background region other than the photographic subject is indicated in black. The region indicated in black is a region where no data exists. The region indicated in white represents pixels of the image of the photographic subject and corresponds to the display region of the metallic ornament 2. The third step is performed by the image processing part 222.

Further, in a fourth step, a range image 1C of the stuffed toy 1 and a range image 2C of the metallic ornament 2 are acquired. The range image 1C and the range image 2C are acquired by separately photographing the stuffed toy 1 and the metallic ornament 2 by the infrared camera 190. The fourth step is performed by the image processing part 222 simultaneously with the second step and the third step.

Next, in the fifth step, a range image 1D in the specific region and a range image 2D in the specific region are acquired respectively by extracting, from the range images 1C and 2C, images that correspond to pixels in the specific regions included in the images 1B and 2B. The fifth step is performed by the range image extracting part 223.

Next, in a sixth step, ratios of noise included in the range images 1D and 2D of the specific regions are calculated. It is determined whether the calculated ratios of noise are equal to or greater than a predetermined value. When the calculated ratio of noise included in the range images 1D or 2D of the specific region is equal to or greater than the predetermined value, the photographic subject corresponding to the range image 1D or the range image 2D of the specific region is a glossy object. When the calculated ratio is not equal to or greater than the predetermined value, the photographic subject corresponding to the range image 1D or the range image 2D of the specific region is a non-glossy object.

As an example herein, the photographic subject (stuffed toy 1) corresponding to the range image 1D of the specific region is determined to be a non-glossy object, and the photographic subject (metallic ornament 2) corresponding to the range image 2D of the specific region is determined to be a glossy object.

To a region 1E that includes the range image 1D of the specific region determined to be a non-glossy object (hereinafter referred to as a non-glossy region 1E), amplitude data representing relatively small amplitude that corresponds to the non-glossy object is allocated.

To a region 2E that includes the range image 2D of the specific region determined to be a glossy object (hereinafter referred to as a glossy region 2E), amplitude data representing relatively large amplitude that corresponds to the glossy object is allocated.

In this way, the data representing the non-glossy region 1E and the glossy region 2E to which the amplitude data is allocated, respectively, is stored in the memory 250. The sixth step is now completed. The sixth step is performed by the gloss determining part 224 and the amplitude data allocating part 225.

Subsequently, in a seventh step, the image 2A of the metallic ornament 2 is displayed on the display panel 160 of the electronic device 100. When the user's finger traces the region that displays the image 2A, the vibrating element 140 is driven and the tactile sensation appropriate to the metallic ornament 2 is provided.

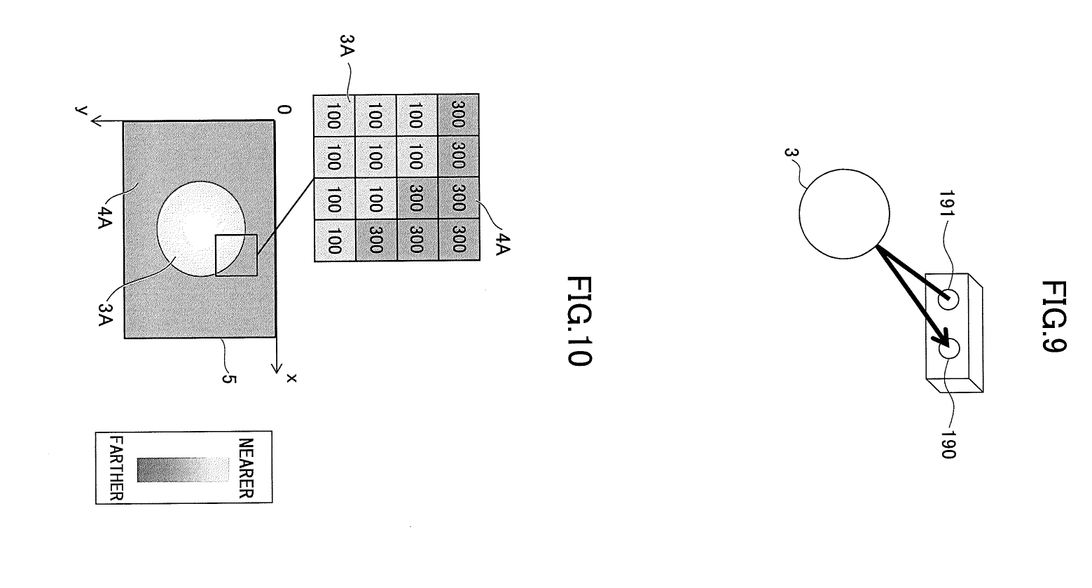

Next, range images acquired by the infrared camera 190 will be described with reference to FIG. 9 and FIG. 10.

FIG. 9 and FIG. 10 are drawings illustrating range images acquired by the infrared camera 190.

As illustrated in FIG. 9, infrared light is irradiated from the infrared light source 191 onto an object 3 (a photographic subject). Then, the infrared light is diffusely reflected by the surface of the object 3. The infrared light reflected by the object 3 is imaged by the infrared camera 190. As a result, a range image is acquired.

A range image 5 illustrated at the bottom of FIG. 10 includes a range image 3A of the object 3 and a range image 4A of the background. The range image is provided with range information for each pixel. However, in the range image 5 illustrated in the lower side of FIG. 10, the distance from the infrared camera 190 is illustrated in greyscale for convenience of explanation. In FIG. 10, a region nearer to the infrared camera 190 is indicated in light gray and a region farther from the infrared camera 190 is indicated in dark gray. When viewed from the infrared camera 190, the object 3 is nearer than the background. Therefore, the range image 3A of the object 3 is indicated in light gray and the range image 4A of the background is indicated in dark gray.

A part (a part enclosed in a box) of the range image 5 illustrated in the lower side of FIG. 10 is enlarged and illustrated in the upper side of FIG. 10. The range image 5 is provided with range information for each pixel. As an example herein, the range image 3A of the object 3 has range information of 100 (mm) and the range image 4A of the background has range information of 300 (mm).

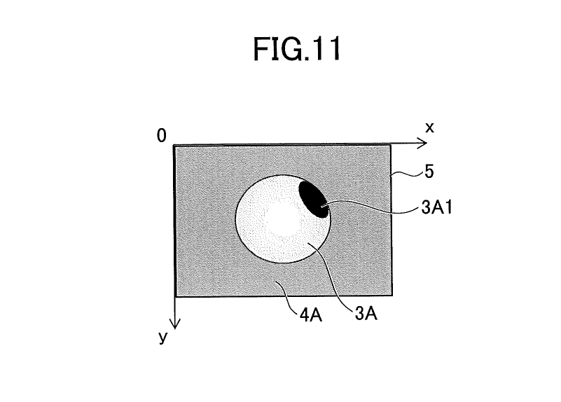

Next, noise included in the range image will be described with reference to FIG. 11.

FIG. 11 is a drawing illustrating the range image 5 including noise 3A1.

If the object 3 is a glossy object, it has high specular reflection characteristics that cause high reflection in a certain direction. Therefore, for some pixels, there may be a case in which reflected light does not return to the infrared camera 190. Such pixels, for which reflected light of infrared light irradiated from the infrared light source 191 did not return, lack optical data about the reflected light and thus become the noise 3A1. Because the noise 3A1 does not have any optical data, it is illustrated in black. Further, the noise 3A1 is regarded as a data lacking portion that lacks data about reflected light.

The electronic device 100 of the first embodiment determines whether the object 3 is a glossy object by using the noise 3A1, and allocates amplitude data based on the determined result.

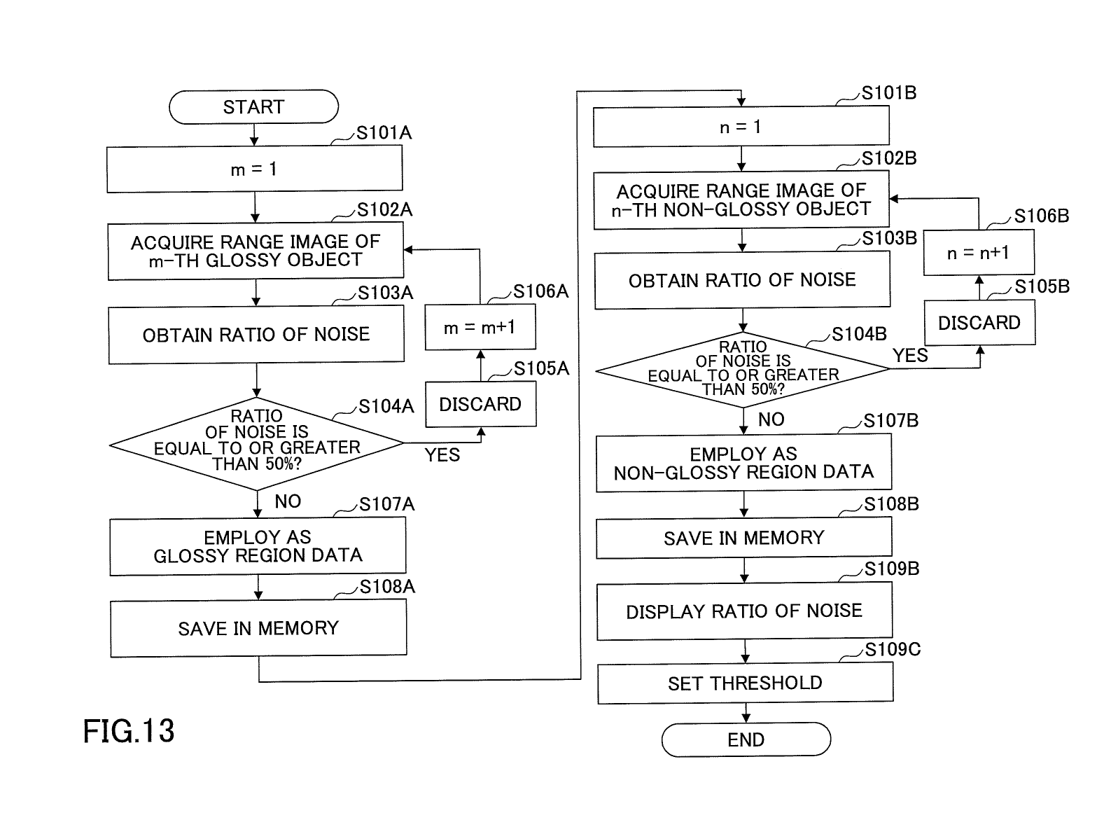

FIG. 12 and FIG. 13 illustrate flowcharts of processing for allocating amplitude data executed by the electronic device 100 of the first embodiment. The processing illustrated in FIG. 12 and FIG. 13 is executed by the application processor 220.

The application processor 220 determines a threshold (step S100). The threshold is used as a reference value for determining whether a ratio of noise included in the range image of the specific region is small or large in step S170, which is performed later. The processing in Step S100 is executed by the image processing part 222 of the application processor 220.

At this time, the application processor 220 displays, on the display panel 160, an input screen for setting a threshold, and prompts the user to set a threshold. The user sets a threshold by manipulating the input screen of the display panel 160. Also, the processing executed by the application processor 220 when the user manipulates the input screen will be described below with reference to FIG. 13.

The application processor 220 photographs a photographic subject by using the camera 180 and the infrared camera 190 (step S110). The application processor 220 displays, on the display panel 160, a message requesting the user to photograph the photographic subject. Upon the user photographing the photographic subject by using the camera 180 and the infrared camera 190, the processing in step S110 is achieved.

Further, the processing in step S110 is executed by the camera controlling part 221 and corresponds to the first step illustrated in FIG. 8.

Upon the completion of step S110, the application processor 220 executes steps S120 and S130 simultaneously with step S140.

The application processor 220 acquires a color image from the camera 180 (step S120). The processing in step S120 is executed by the camera controlling part 221 and the image processing part 222 and corresponds to the second step illustrated in FIG. 8.

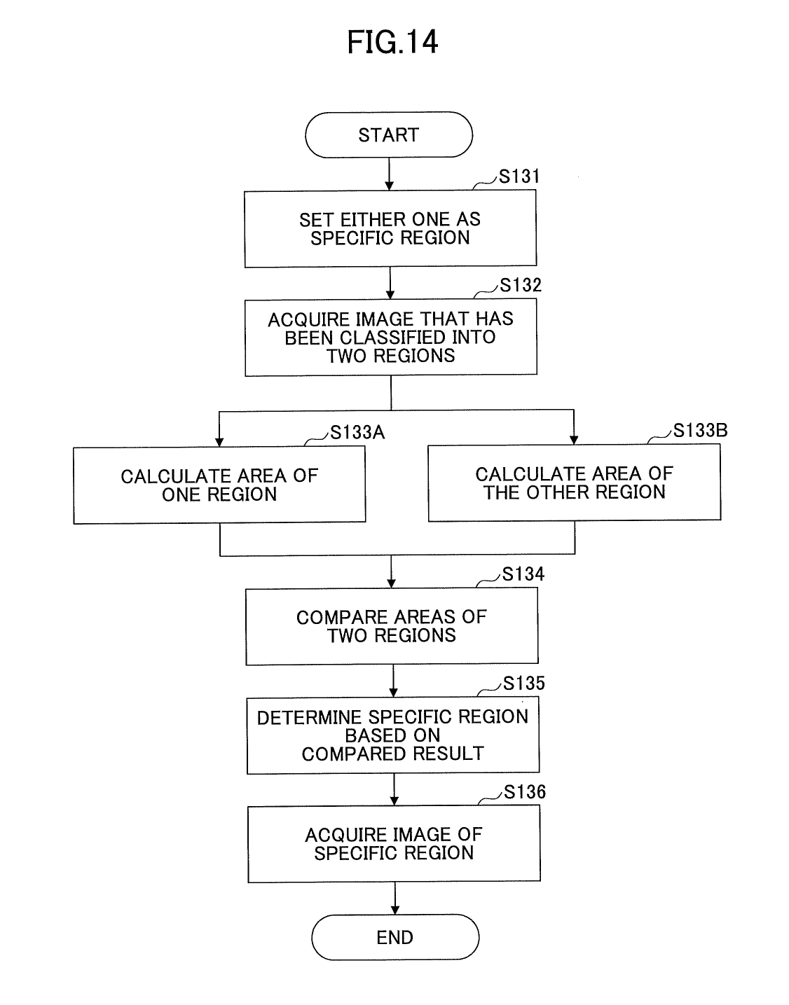

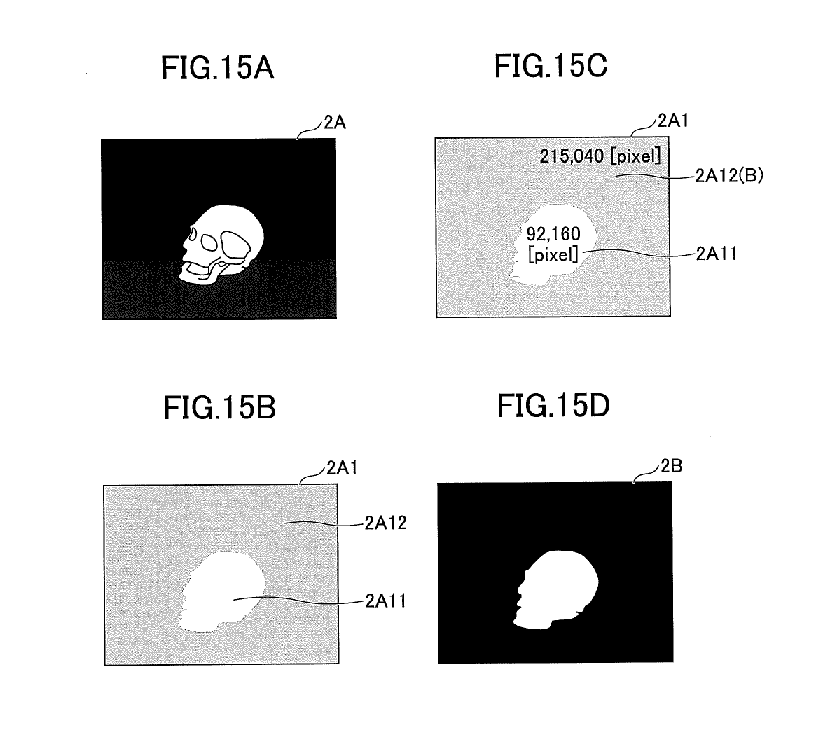

The application processor 220 acquires an image of the specific region by image-processing the color image acquired in step S120 (step S130). The processing in step S130 is executed by the image processing part 222 and corresponds to the third step illustrated in FIG. 8. Further, the details of processing for acquiring an image of the specific region will be described with reference to FIG. 14 and FIG. 15.

In addition, the application processor 220 acquires a range image from the infrared camera 190 (step S140). Step S140 corresponds to the fourth step illustrated in FIG. 8.

The application processor 220 acquires a range image of the specific region based on the image of the specific region acquired in step S130 and the range image acquired in step S140 (step S150). The range image of the specific region represents a range image of the photographic subject. The processing in step S150 is executed by the camera controlling part 221 and the image processing part 222 and corresponds to the fifth step illustrated in FIG. 8.

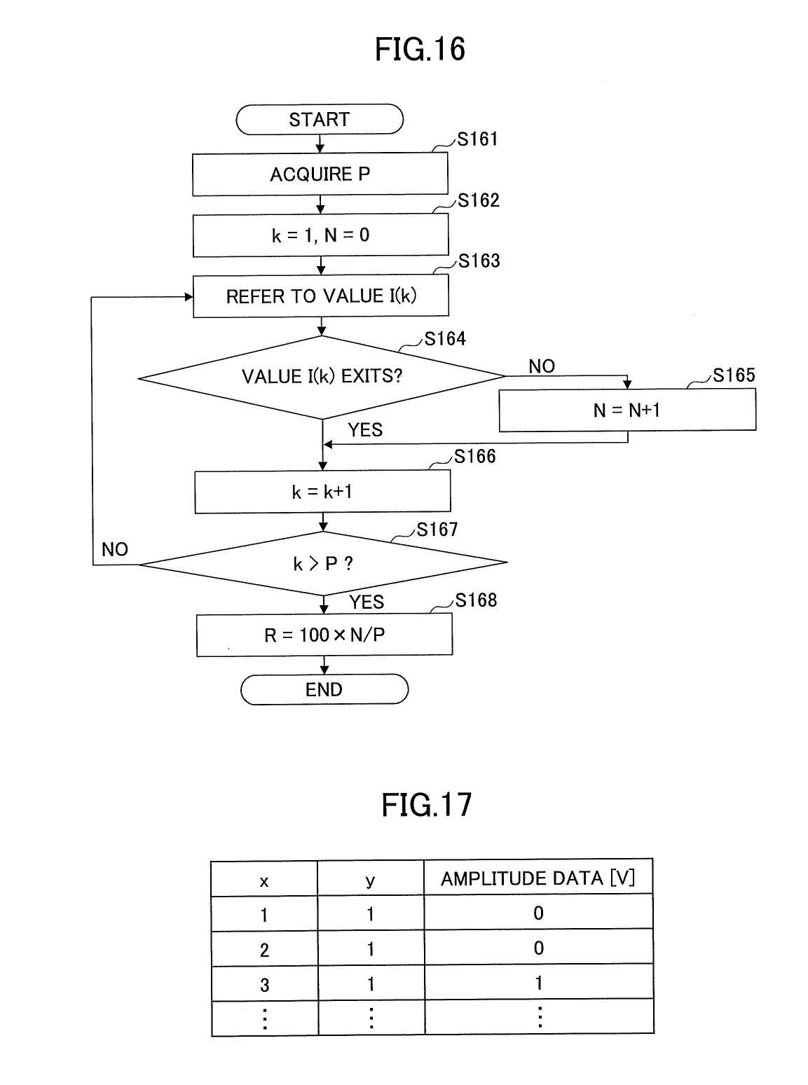

Next, the application processor 220 obtains a ratio of noise included in the range image of the specific region acquired in step S150 to the range image of the specific region (step S160). The processing in step S160 is executed by the gloss determining part 224 and corresponds to the sixth step illustrated in FIG. 8. The details of a method for obtaining a ratio of noise will be described with reference to FIG. 16.

The application processor 220 determines whether the ratio of noise obtained in step S100 is equal to or greater than the threshold acquired in step S100 (step S170). Step S170 corresponds to the sixth step illustrated in FIG. 8.

When the application processor 220 determines that the ratio of noise is not equal to or greater than the threshold (NO in S170), it is determined that the specific region is a non-glossy region (step S180A). The processing in step S180A is executed by the gloss determining part 224 and corresponds to the sixth step illustrated in FIG. 8.

When the application processor 220 determines that the ratio of noise is equal to or greater than the threshold (YES in S170), it is determined that the specific region is a glossy region (step S180B). The processing in step S180B is executed by the gloss determining part 224 and corresponds to the sixth step illustrated in FIG. 8.

The application processor 220 allocates amplitude data based on the result determined in step S180A or in step S180B to the specific region (step S190). The application processor 220 stores data representing the specific region to which the amplitude data is allocated in the memory 250. The processing in step S190 is executed by the amplitude data allocating part 225 and corresponds to the sixth step illustrated in FIG. 8.

The processing illustrated in FIG. 13 is started upon the start of step S100.

Firstly, the application processor 220 sets the number m (m represents an integer of 1 or more) of glossy objects (hereinafter referred to as glossy objects) to 1 (step S101A). This setting is a preparation for acquiring a color image of the first glossy object.

The application processor 220 acquires a range image of the m-th glossy object (step S102A). In the same way as described in steps S110, S120, S130, S140, and S150, based on the color image acquired from the camera 180 and the range image acquired from the infrared camera 190, a range image of the glossy object is acquired by acquiring a range image of the specific region that corresponds to the glossy object.

Namely, the range image of only the glossy object, which is included in the field of view when photographed by the camera 180 and the infrared camera 190, respectively, is acquired as the range image of the specific region that corresponds to the glossy object.

Further, the color image and the range image employed in step S102A may be acquired by photographing a glossy object at hand by using the camera 180 and the infrared camera 190.

Alternatively, the user may read the color image and the range image preliminarily saved in the memory 250 of the electronic device 100.

The application processor 220 obtains a ratio of noise of the m-th glossy object (step S103A). The ratio of noise can be obtained in the same way as step S160 by processing the range image of the specific region, which has been acquired in step S102A.

The application processor 220 determines whether the ratio of noise is equal to or greater than 50% (step S104A). The threshold for determining the ratio of noise is set to 50% as an example herein. The user may set any threshold value according to the user's preference.

When the application processor 220 determines that the ratio of noise is equal to or greater than 50% (YES in S104A), the range image of the specific region, whose ratio of noise has been determined to be equal to or greater than 50%, is discarded (step S105A). This is because the range image of the specific region whose ratio of noise is equal to or greater than 50% is not suitable for a region of the glossy object (glossy region) where the range image of the specific region is included.

The number m is incremented by the application processor 220 (step S106A). Namely, the number m is incremented as m=m+1. Upon the completion of the processing in step S106A, the application processor 220 causes the flow to return to step S102A.

Also, when the application processor 220 determines that the ratio of noise is not equal to or greater than 50% (NO in S104A), the range image of the specific region and its ratio of noise are employed as glossy region data (step S107A).

The application processor 220 saves the glossy region data employed in step S107A in the memory 250 (step S108A). Upon the completion of step S108A, the application processor 220 causes the flow to proceed to step S101B.

The application processor 220 sets the number n (n represents an integer of 1 or more) of non-glossy objects (hereinafter referred to as non-glossy objects) to 1 (step S101B). This is a preparation for acquiring a color image of the first non-glossy object.

The application processor 220 acquires a range image of the n-th non-glossy object (step S102B). In the same way as described in steps S110, S120, S130, S140, and S150, based on the color image acquired from the camera 180 and the range image acquired from the infrared camera 190, a range image of the non-glossy object is acquired by acquiring a range image of the specific region that corresponds to the non-glossy object.

Namely, the range image of only the non-glossy object, which is included in the field of view when photographed by the camera 180 and the infrared camera 190, respectively, is acquired as the range image of the specific region that corresponds to the non-glossy object.

Further, the color image and the range image employed in step S102B may be acquired by photographing a non-glossy object at hand by using the camera 180 and the infrared camera 190. Alternatively, the user may read the color image and the range image preliminarily saved in the memory 250 of the electronic device 100.

The application processor 220 obtains a ratio of noise of the n-th non-glossy object (step S103B). The ratio of noise can be obtained in the same way as step S160 by processing the range image of the specific region, which has been acquired in step S102B.

The application processor 220 determines whether the ratio of noise is equal to or greater than 50% (step S104B). The threshold for determining the ratio of noise is set to 50% as an example herein. The user may set any threshold value according to the user's preference.

When the application processor 220 determines that the ratio of noise is equal to or greater than 50% (YES in S104B), the range image of the specific region, whose ratio of noise has been determined to be equal to or greater than 50%, is discarded (step S105B). This is because the range image of the specific region whose ratio of noise is equal to or greater than 50% is not suitable for a region of the non-glossy object (non-glossy region) where the range image of the specific region is included.

The number n is incremented by the application processor 220 (step S160B). Namely, the number n is incremented as n=n+1. Upon the completion of the processing in step S160B, the application processor 220 causes the flow to return to step S102B.

Also, when the application processor 220 determines that the ratio of noise is not equal to or greater than 50% (NO in S104B), the range image of the specific region and its ratio of noise are employed as non-glossy region data (step S107B).

The application processor 220 saves the non-glossy region data employed in step S107B in the memory 250 (step S108B).

The application processor 220 displays, on the display panel 160, the ratios of noise of the specific regions included in the glossy region data and in the non-glossy region data saved in the memory 250 (step S109B).

For reference by the user who sets a threshold for a ratio of noise, it is preferable to display the ratios of noise of the specific regions included in the glossy region data and in the non-glossy region data, respectively.

The application processor 220 sets a threshold to the value specified by the user's manipulation input (step S109C).

For example, for the metallic ornament 2, the ratio of noise of the specific region is 5%, and for the stuffed toy 1, the ratio of noise of the specific region is 0%. In this case, the user sets a threshold for the ratio of noise to 2.5%, for example.

As described above, the threshold described in S100 is determined.

FIG. 14 is a flowchart illustrating the processing in step S130 in detail. The flow illustrated in FIG. 14 will be described with reference to FIGS. 15A through 15D. FIGS. 15A through 15D are drawings illustrating image processing performed in step S130.

The application processor 220 sets either one of the larger area or the smaller area of the color image, which will be classified into two regions in step S132, as the specific region (step S131). Whether the larger area or the smaller area is set as the specific region is decided by the user. Herein, the specific region refers to a region that represents a display region of a photographic subject.

The reason why the above-described setting is configured is because a magnitude relationship between a photographic subject and a background becomes different, depending on whether the photographic subject is photographed in a larger size or photographed in a smaller size.

A region having a smaller area than that of the other region is set as the specific region, as an example herein.

The application processor 220 acquires the color image that has been classified into the two regions, one of which is the photographic subject and the other is the background, by using a graph-cut method (step S132). For example, by performing a graph-cut method for the image 2A (color image) illustrated in FIG. 15A, an image 2A1 illustrated in FIG. 15B is obtained. The image 2A1 is classified into a region 2A11 and a region 2A12.

At this point, whether either the region 2A11 or the region 2A12 is the display region of the photographic subject is unknown.

Next, the application processor 220 calculates an area of one region 2A11 and an area of the other region 2A12 (steps S133A and S133B). For example, an area of the region 2A11 and an area of the region 2A12 may be calculated by counting the number of pixels included in the region 2A11 and the region 2A12, respectively.

For example, in an XY coordinate system as illustrated in FIG. 10, pixels may be counted, starting with the pixel closest to the origin 0, moving in the positive direction of the x-axis (positive column direction), and moving down row by row in the positive direction of the y-axis (positive row direction). In this way, all pixels may be counted.

For example, as illustrated in FIG. 15C, it is assumed that the number of pixels in the region 2A11 is 92,160 pixels and the number of pixels in the region 2A12 is 215,040 pixels.

The application processor 220 compares the area calculated in step S133A with the area calculated in step S133B (step S134).

Next, the application processor 220 determines the specific region based on the compared result (step S135). By way of example herein, a region having a smaller area than that of the other region has been set to be the specific region that represents the display region of the photographic subject in step S131. Therefore, of the region 2A11 and the region 2A12, the region 2A11 having a smaller area is determined as the specific region.

Next, the application processor 220 acquires an image of the specific region (step S136). For example, the image 2B (see FIG. 15D), which corresponds to FIG. 15B in which the region 2A11 is the specific region, is acquired.

In the image 2B, the specific region, which is a region that displays the photographic subject, is indicated in white. The background region other than the region that displays the photographic subject is indicated in black. In the image 2B, only the specific region contains data. The data contained in the specific region represents pixels of the image of the photographic subject.

Next, processing for obtaining a ratio of noise will be described with reference to FIG. 16.

FIG. 16 is a flowchart illustrating processing for acquiring a ratio of noise.

The flow in FIG. 16 illustrates the details of the processing for determining the ratio of noise in step S160. The flow illustrated in FIG. 16 is executed by the amplitude data allocating part 225.

Hereinafter, P refers to the number of pixels included in the specific region. I(k) refers to a value representing a distance given to the k-th (1≦k≦P) pixel, of the pixels included in the specific region. N (0≦N≦P) refers to the number of pixels in which noise appears. R (0%≦R≦100%) refers to a ratio of noise.

Similarly to the case in which pixels are counted, the k-th pixel may be counted by assigning an order to each pixel, starting with the pixel closest to the origin 0, moving in the positive direction of the x-axis (positive column direction), and moving down row by row in the positive direction of the y-axis (positive row direction).

Upon the starting of the processing, the application processor 220 acquires the number of pixels P of the range image included in the specific region (step S161). Of the two regions whose pixels have been counted in step S133A and S133B, the number of pixels in the region that has been determined to be the specific region may be acquired. For example, 92,160 pixels, which is the number of pixels in the region 2A11 illustrated in FIG. 15C, is acquired.

The application processor 220 sets k=1 and N=0 (step S162).

The application processor 220 refers to the value I(k) that represents the distance given to the k-th pixel (step S163). The value I(k) may be read from the k-th pixel in the specific region.

The application processor 220 determines whether the value I(k) that represents the distance given to the k-th pixel exists (step S164). When the value I(k) that represents the distance is zero, it is determined that the value I(k) does not exist. When the value I(k) that represents the distance is not zero (if the positive value exists), it is determined that the value I(k) exists.

When the application processor 220 determines that the value I(k) that represents the distance does not exist (NO in S164), the number of pixels N in which noise appears is incremented (step S165). The number of pixels n is incremented as n=n+1. Upon the completion of the processing in step S165, the application processor 220 causes the flow to proceed to S166.

When the application processor 220 determines that the value I(k) that represents the distance exists (YES in S164), the application processor 220 causes the flow to proceed to step S166. The value k is incremented (step S166). Namely, the value k is incremented as k=k+1.

The application processor 220 determines whether k>P is established (step S167).

When the application processor 220 determines that k>P is not established (NO in S167), the flow returns to step S163.

When the application processor 220 determines that k>P is established (YES in S167), the flow proceeds to step S168. Herein, k>P is established when the processing is completed for all the pixels included in the specific region as well as when k=P+1 is established for all the pixels.

The application processor 220 obtains a ratio of noise (step S168). The ratio of noise is acquired by the following formula (3):

R=100·N/P (3)

Namely, the ratio of noise, which is expressed as a percentage, is a ratio of the number of pixels in which noise appears to the total number of pixels P.

As described above, the ratio of noise in step S160 is obtained.

FIG. 17 is a drawing illustrating the amplitude data allocated by the amplitude data allocating part to the specific region.

The pixels in the specific region are expressed as XY coordinates illustrated in FIG. 10. FIG. 17 illustrates the amplitude data (voltage values) allocated to pixels located in the first column, the second column, and the third column in the x-axis direction, all of which are located in the first row in the y-axis direction.

The first column in the x-axis direction represents the column closest to the origin 0 in the x-axis direction. The first row in the y-axis direction represents the row closest to the origin 0 in the y-axis direction. The data in FIG. 17 illustrates amplitude values that are given to the pixels closest to the origin of the specific region. Further values exist in the x-axis direction and in the y-axis direction.

Moreover, amplitude data for glossy objects and amplitude data for non-glossy objects are stored in the memory 250. The amplitude data allocating part 225 may read such amplitude data when allocating the amplitude data to each pixel in the specific region.

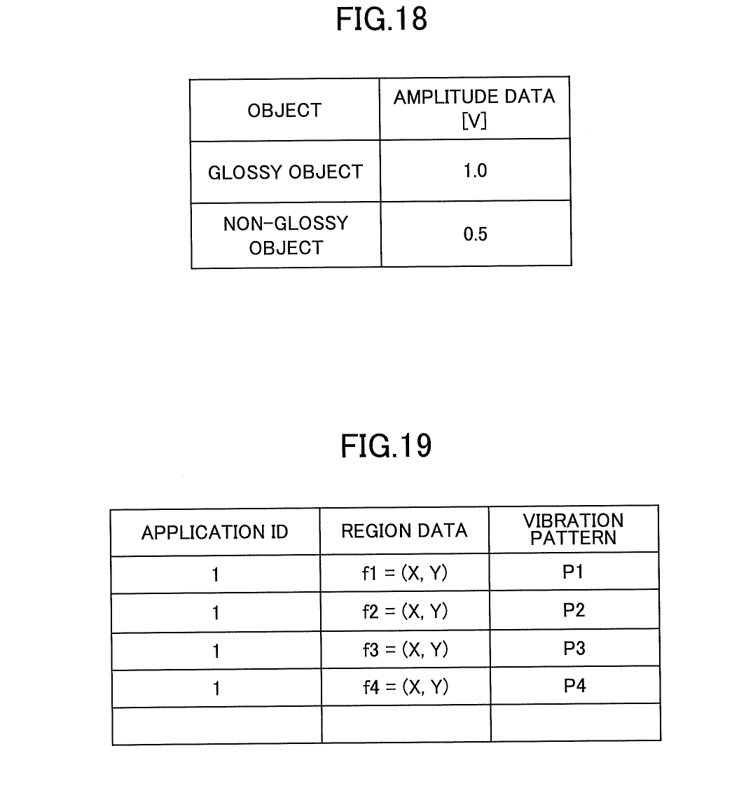

FIG. 18 is a drawing illustrating amplitude data for glossy objects and amplitude data for non-glossy objects stored in the memory 250.

In FIG. 18, the amplitude data for glossy objects is set to 1.0 (V) and the amplitude data for non-glossy objects is set to 0.5 (V), for example. In addition, amplitude data may be set to different values for each pixel in the specific region. For example, in the case of the stuffed toy 1 (see FIG. 8) whose surface has projecting and recessed portions, amplitude data may be changed periodically by a certain number of pixels. By allocating such amplitude data to the specific region, a tactile sensation of the surface of the stuffed toy 1 can be properly produced.

FIG. 19 is a drawing illustrating data stored in the memory 250.

The data illustrated in FIG. 19 is data that associates data representing types of applications, region data representing coordinate values of specific regions, and pattern data representing vibration patterns with one another.

As the data representing types of applications, application identifications (IDs) are illustrated. The application IDs may be assigned to each specific region with which vibration data is associated. Namely, the application ID of the specific region of the stuffed toy 1 (see FIG. 8) may be different from the application ID of the specific region of the metallic ornament 2 (see FIG. 8).

Also, as the region data, formulas f1 to f4 that express coordinate values of specific regions are illustrated. For example, the formulas f1 to f4 are formulas that express coordinates of specific regions such as the specific regions (see the third step in FIG. 8) included in the image 1B and the image 2B. In addition, as the pattern data that represents vibration patterns, P1 to P4 are illustrated. The pattern data P1 to P4 is data in which the amplitude data illustrated in FIG. 18 is allocated to each pixel in the specific region.

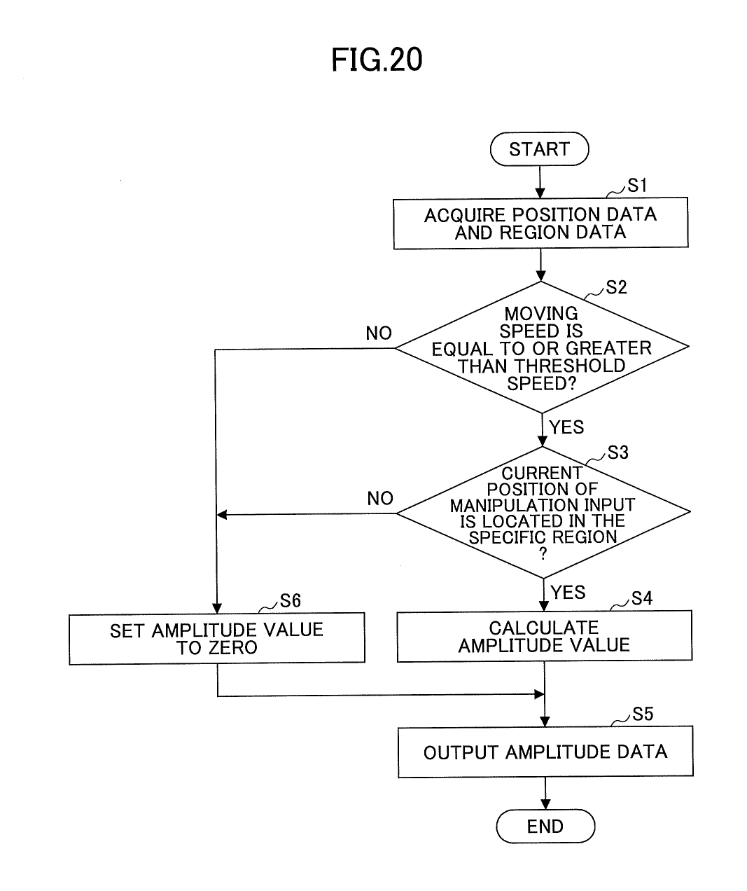

Next, processing executed by the drive controlling part 240 of the electronic device 100 of the embodiment will be described with reference to FIG. 20.

FIG. 20 is a flowchart illustrating processing executed by the drive controlling part of the electronic device of the embodiment.

An operating system (OS) of the electronic device 100 executes control for driving the electronic device 100 for each predetermined control cycle. Therefore, the drive controlling part 240 performs the flow illustrated in FIG. 20 repeatedly for each predetermined control cycle.

The drive controlling part 240 starts the processing upon the electronic device 100 being turned on.

The drive controlling part 240 acquires the region data with which a vibration pattern is associated in accordance with the type of the current application type (step S1).

The drive controlling part 240 determines whether the moving speed is greater than or equal to the predetermined threshold speed (step S2). The moving speed may be calculated by using vector processing. Furthermore, the threshold speed may be set to the minimum speed of the moving speed of the fingertip when manipulation inputs such as what are known as the flick operation, the swipe operation, or the drag operation are performed by moving the fingertip. Such a minimum speed may be set based on, for example, experiment results, the resolution of the touch panel 150, and the like.

When the drive controlling part 240 determines that the moving speed is equal to or greater than the predetermined threshold speed in step S2, the drive controlling part 240 determines whether the current coordinates represented by the position data are located in the specific region represented by the region data obtained in step S1 (step S3).

When the drive controlling part 240 determines that the current coordinates represented by the position data are located in the specific region represented by the region data obtained in step S1, the vibration pattern corresponding to the current coordinates represented by the position data is obtained from the data illustrated in FIG. 19 (step S4).

The drive controlling part 240 outputs the amplitude data (step S5). As a result, the amplitude modulator 320 generates the driving signal by modulating the amplitude of the sinusoidal wave output from the sinusoidal wave generator 310, and the vibrating element 140 is driven.

In step S2, when the drive controlling part 240 determines that the moving speed is not equal to or greater than the predetermined threshold speed (NO in S2) or when the drive controlling part 240 determines, in step S3, that the current coordinates are not located in the specific region represented by the region data obtained in step S1, the drive controlling part 240 sets the amplitude value to zero (step S6).

As a result, the drive controlling part 240 outputs amplitude data whose amplitude value is zero, and the amplitude modulator 320 generates a driving signal by modulating the amplitude of the sinusoidal wave output from the sinusoidal wave generator 310 to zero. Therefore, the vibrating element 140 is not driven.

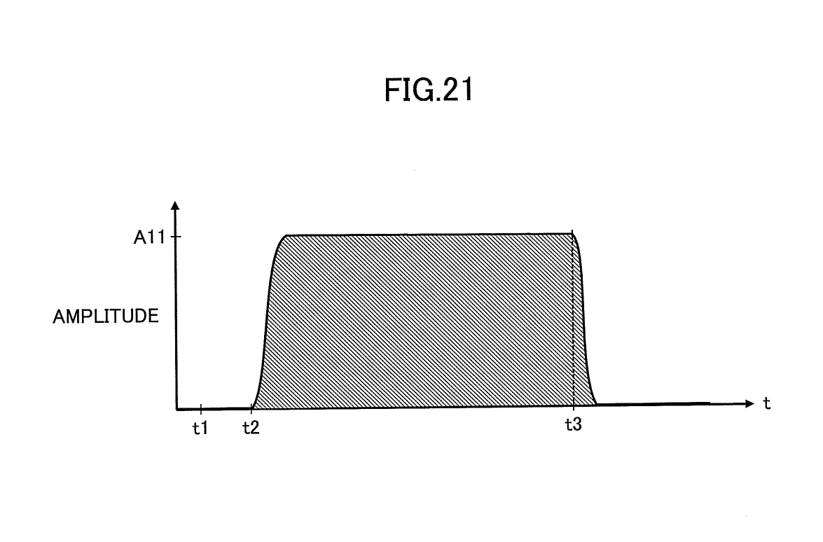

FIG. 21 is a drawing illustrating an example of an operation of the electronic device of the first embodiment.

In FIG. 21, a horizontal axis represents time and a vertical axis represents an amplitude value of the amplitude data. Herein, the moving speed of the user's fingertip along the surface 120A of the top panel 120 is assumed to be almost constant. Also, a glossy object is displayed on the display panel 160. The user traces the image of the glossy object.

The user's fingertip, located outside the specific region, begins to move leftward along the surface of the top panel 120 at a time point t1. Subsequently, at a time point t2, when the fingertip enters the specific region that displays the glossy object, the drive controlling part 240 causes the vibrating element 140 to vibrate.

The amplitude of the vibration pattern at this time is A11. The vibration pattern has a driving pattern in which the vibration continues while the fingertip is moving in the specific region.

When the user's fingertip moves outside the specific region at a time point t3, the drive controlling part 240 sets the amplitude value to zero. Therefore, immediately after the time point t3, the amplitude becomes zero.

In this way, while the fingertip is moving in the specific region, the drive controlling part 240 outputs the amplitude data having the constant amplitude value (A11), for example. Therefore, the kinetic friction force applied to the user's fingertip is lowered while the user's fingertip is touching and tracing the image of the object displayed in the specific region. As a result, the sensation of slipperiness and smoothness can be provided to the user's fingertip. Accordingly, the user can feel the tactile sensation of the glossy object. In the case of a non-glossy object, as the amplitude is smaller, the tactile sensation becomes gentle. For example, when the non-glossy object is the stuffed toy 1 (see FIG. 8), a fluffy and soft tactile sensation is provided.

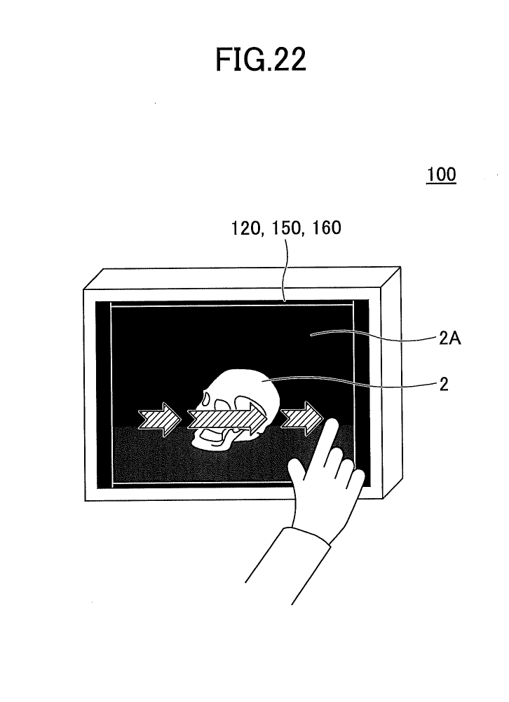

FIG. 22 is a drawing illustrating a use scene of the electronic device 100.

After the amplitude data is allocated to the specific region, the user displays the image 2A of the metallic ornament 2 having a shape of a skull on the display panel 160 of the electronic device 100. When the user's finger traces other regions than the specific region that displays the metallic ornament 2 on the top panel 120, the vibrating element 140 is not driven (see FIGS. 2, 3, and 7). Therefore, no squeeze effect is generated.

When the user's fingertip moves in the specific region that displays the metallic ornament 2, the vibrating element 140 is driven by the driving signal whose intensity has been modulated by using the amplitude data allocated to the specific region, as described above.

As a result, when the user's fingertip moves in the specific region that displays the metallic ornament 2, the sensation of slipperiness can be provided by a squeeze effect.

Namely, the user's fingertip moves slowly in other regions than the specific region that displays the metallic ornament 2, as indicated by a short arrow, and the user's fingertip moves at a fast speed in the specific region that displays the metallic ornament 2, as indicated by a long arrow.

Also, when the stuffed toy 1 (see FIG. 8) is displayed on the display panel 160 and the finger moves in the specific region that displays the stuffed toy 1, the vibrating element 140 is driven by the driving signal whose intensity has been modulated by using smaller amplitude data than that of the metallic ornament 2. Therefore, a tactile sensation of touching the fluffy stuffed toy 1 can be provided to the user.

According to the first embodiment as described above, it is possible to provide the electronic device 100 and the drive controlling method that can provide a tactile sensation based on the presence or absence of gloss.

Moreover, the user may freely set the amplitude data allocated to the specific region. In this way, the user can provide different tactile sensations according to the user preference.

Hereinbefore, the embodiment in which the image of the specific region is acquired by processing the color image acquired from the camera 180 has been described. However, the electronic device 100 is not required to include the camera 180. The electronic device 100 may obtain an infrared image from the infrared camera 190 and may obtain an image of the specific region by image-processing the infrared image instead of the above-described color image. The infrared image refers to an image acquired by irradiating infrared light onto a photographic subject and converting the intensity of the reflected light into pixel values. The infrared image is displayed in black and white.

In this case, the infrared image may be displayed on the display panel 160 of the electronic device 100.

In addition, in a case where an image of the specific region is acquired by image-processing a color image acquired from the camera 180, an infrared image acquired from the infrared camera 190 may be displayed on the display panel 160.

Conversely, in a case where an image of the specific region is acquired by image-processing an infrared image acquired from the infrared camera 190, a color image acquired from the camera 180 may be displayed on the display panel 160.

An image acquired from the camera 180 is not required to be a color image and may be a black-and-white image.

### Second Embodiment

In the second embodiment, a setting for determining a threshold in step S100 (see FIG. 12) differs from that of the first embodiment. Other configurations are similar to those of the electronic device 100 of the first embodiment. Therefore, the same reference numerals are given to the similar configuration elements and thus their descriptions are omitted.

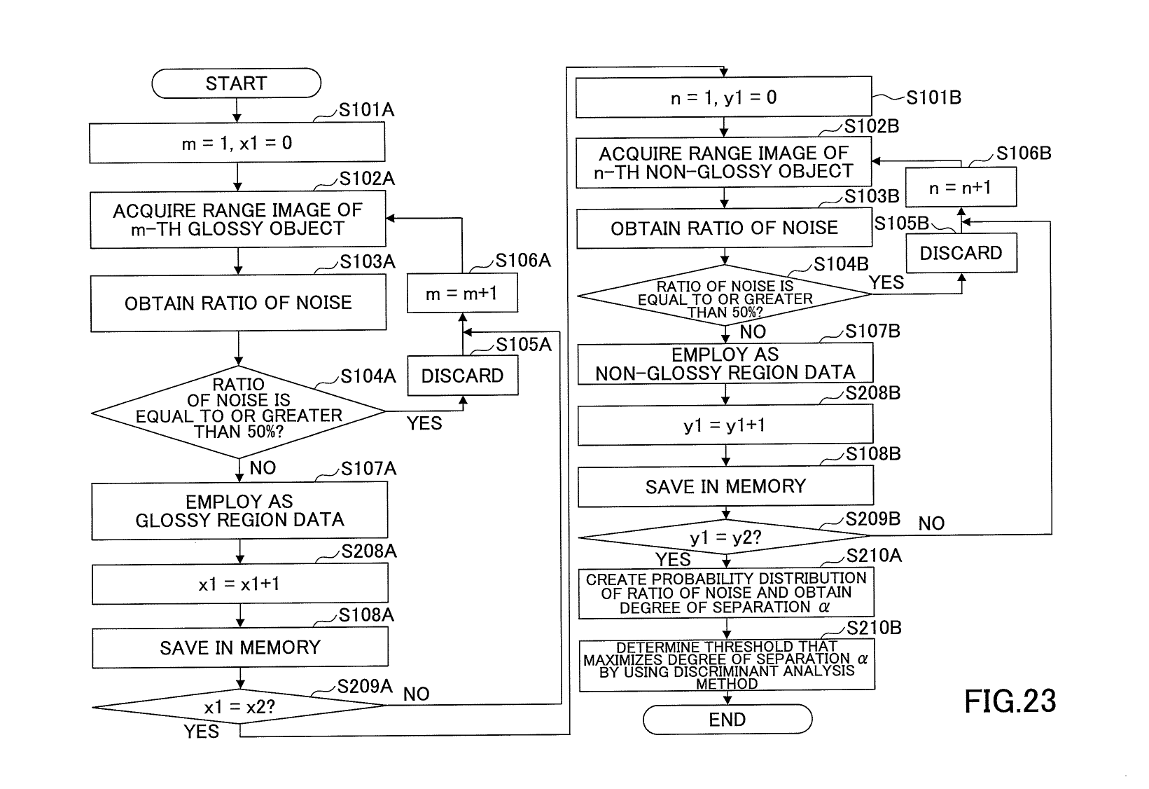

FIG. 23 is a flowchart illustrating processing for allocating amplitude data executed by an electronic device 100 of the second embodiment. The processing illustrated in FIG. 23 is executed by the application processor 220.

In the flow illustrated in FIG. 23, steps S101A through S108A and steps S101B through S108B are similar to steps S101A through S108A and steps S101B through S108B illustrated in FIG. 13.

However, in step S101A, processing for setting the number x1 of glossy region data groups to 0 (zero) is added. Also, in step S101B, processing for setting the number y1 of non-glossy region data groups to 0 (zero) is added. The numbers x1 and y1 represent an integer of 2 or more, respectively.

In addition, step S208A is added between steps S107A and S108A. Also, step S209A is added between steps S108A and S101B.

Further, step S208B is added between steps S107B and S108B. Also, following step S108B, steps S209B, S210A, and S210B are included.

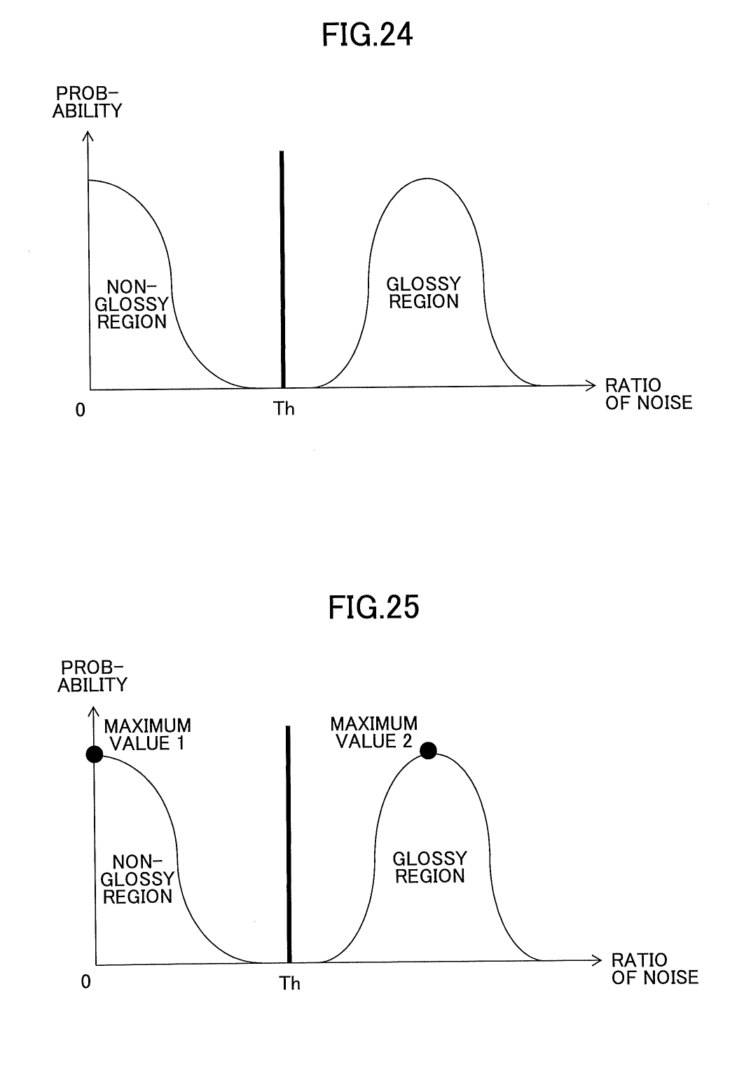

By way of example herein, the application processor 220 automatically determines a threshold by using a discriminant analysis method. The discriminant analysis method is an approach for dividing histograms into two classes. Therefore, a description will be given with reference to FIG. 24 in addition to FIG. 23. FIG. 24 is a drawing illustrating a probability distribution of a ratio of noise.

In the second embodiment, the application processor 220 sets the number m (m represents an integer of 1 or more) of glossy objects (hereinafter glossy objects) to 1. Also, the application processor 220 sets the number x1 of glossy region data groups to 0 (zero) (step S101A). This setting is a preparation for acquiring a color image of the first glossy object.

Next, the application processor 220 executes the same processing as that in step S102A through step S107A of the first embodiment.

Upon the glossy region data being employed in step S107A, the number x1 of glossy region data groups is incremented by the application processor 220 (step S208A).

Next, the application processor 220 saves the glossy region data employed in step S107A in the memory 250 (step S108A).

Next, the application processor 220 determines whether the number x1 of glossy region data groups reaches a predetermined number x2 (step S209A). The predetermined number x2, which has been preliminarily set, is the necessary number of glossy region data groups. The predetermined number x2 of glossy region data groups may be determined and set by the user or may be preliminarily set by the electronic device 100.

When the application processor 220 determines that the number x1 of glossy region data groups reaches the predetermined number x2 (YES in S209A), the flow proceeds to step S101B.

Also, when the application processor 220 determines that the number x1 of glossy region data groups does not reach the predetermined number x2 (NO in S209A), the flow returns to step S106A. In response to the result, the processing is repeatedly performed until the number x1 of glossy region data groups reaches the predetermined number x2.

The application processor 220 sets the number n (n represents an integer of 1 or more) of non-glossy objects (hereinafter referred to as non-glossy objects) to 1. The application processor 220 also sets the number y1 of non-glossy region data groups to 0 (zero) (step S101B). This setting is a preparation for acquiring a color image of the first non-glossy object.

Next, the application processor 220 executes the same processing as that in step S102B through step S107B of the first embodiment.

Upon the non-glossy region data being employed in S107B, the number y1 of non-glossy region data groups is incremented by the application processor 220 (step S208B).

Next, the application processor 220 saves the glossy region data employed in step S107B in the memory 250 (step S108B).

Next, the application processor 220 determines whether the number y1 of non-glossy region data groups reaches a predetermined number y2 (step S209B). The predetermined number y2, which has been preliminarily set, is the necessary number of pieces of non-glossy region data groups. The predetermined number y2 of non-glossy region data groups may be determined and set by the user or may be preliminarily set by the electronic device 100.

When the application processor 220 determines that the number y1 of non-glossy region data groups reaches the predetermined number y2 (YES in S209B), the flow proceeds to step S210A.

Also, when the application processor 220 determines that the number y1 of non-glossy region data groups does not reach the predetermined number y2 (NO in S209B), the flow returns to step S160B. In response to the result, the processing is repeatedly performed until the number y1 of glossy region data groups reaches the predetermined number y2.

Upon the completion of the processing in step S209B, the application processor 220 creates a probability distribution of the ratio of noise and obtains a degree of separation α (step S210A).

The application processor 220 sets a temporary threshold Th by using a discriminant analysis method as illustrated in FIG. 24. Subsequently, the application processor 220 calculates the number ω1 of non-glossy region data samples, the mean ml of ratios of noise, the variance σ1 of ratios of noise, the number ω2 of glossy region data samples, the mean m2 of ratios of noise, and the variance σ2 of ratios of noise.

A plurality of data groups employed as glossy region data is referred to as a glossy region data class. A plurality of data groups employed as non-glossy region data is referred to as a non-glossy region data class.

Next, based on these values, the application processor 220 calculates intra-class variance and inter-class variance by using formulas (4) and (5). Subsequently, based on the intra-class variance and the inter-class variance, the application processor 220 calculates the degree of separation α by using a formula (6).

$$\begin{matrix}INTRA \text{-} CLASS VARIANCE \text{:} {σ}_{w}^{2} = \frac{{ω}_{1} {σ}_{1}^{2} + {ω}_{2} {σ}_{2}^{2}}{{ω}_{1} + {ω}_{2}} & ( 4 ) \\ INTER \text{-} CLASS VARIANCE \text{:} {σ}_{b}^{2} = \frac{{ω}_{1} {{ω}_{2} ( {m}_{1} - {m}_{2} )}^{2}}{{( {ω}_{1} + {ω}_{2} )}^{2}} & ( 5 ) \\ DEGREE OF SEPARATION \text{:} α = \frac{{σ}_{b}^{2}}{{σ}_{w}^{2}} & ( 6 )\end{matrix}$$

The application processor 220 repeatedly calculates the degree of separation α by setting different values as a temporary threshold Th.

Eventually, the application processor 220 determines the temporary threshold Th that maximizes the degree of separation α as a threshold used in step S100 (step S210B).

As described above, the threshold used in step S100 can be determined.

Further, instead of using the discriminant analysis method, a mode method may be used. The mode method is an approach for dividing histograms into two classes, similarly to the discriminant analysis method.

When the mode method is used, the following processing may be performed in place of step S210B.

FIG. 25 is a drawing illustrating a method for determining a threshold by using the mode method

First, two maximum values included in the probability distribution are searched. Herein, it is assumed that the maximum value 1 and the maximum value 2 are obtained.

Next, a minimum value between the maximum value 1 and the maximum value 2 is searched. A point that corresponds to the minimum value is determined to be the threshold used in step S100.

### Third Embodiment

In the third embodiment, a method of acquiring an image of the specific region differs from that of step S130 of the first embodiment. Other configurations are similar to those of the electronic device 100 of the first embodiment. Therefore, the same reference numerals are given to the similar configuration elements and thus their descriptions are omitted.

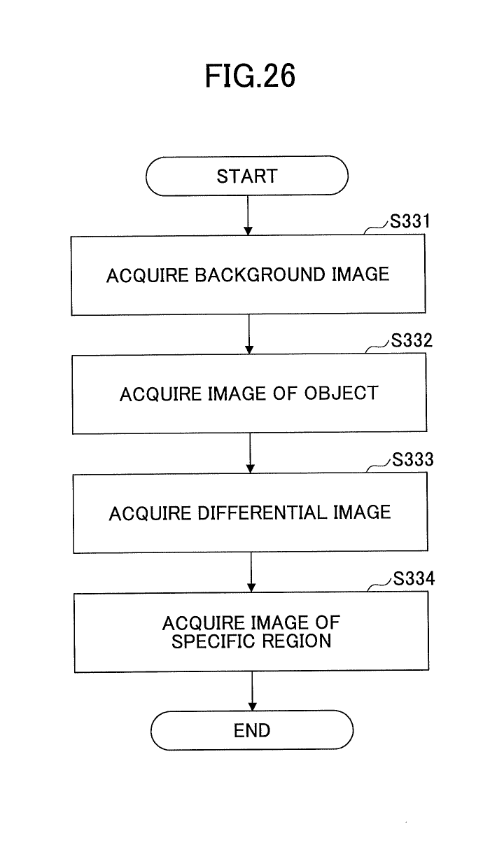

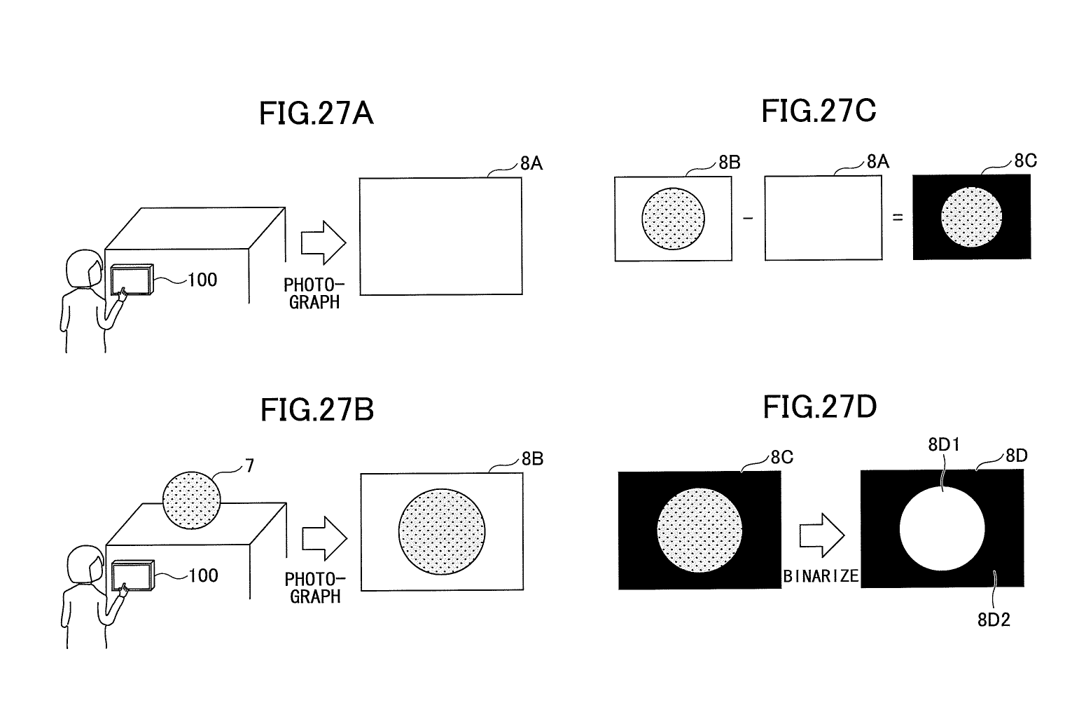

FIG. 26 is a flowchart illustrating a method for acquiring an image of a specific region according to a third embodiment. FIGS. 27A through 27D are drawings illustrating image processing performed according to the flow illustrated in FIG. 26.

The application processor 220 acquires a background image by using the camera 180 (step S331).

For example, as illustrated in FIG. 27A, a background image 8A is acquired by including only the background in the field of view and photographing the background without an object 7 (see FIG. 27B) being placed.

Next, the application processor 220 acquires an image of the object 7 by using the camera 180 (step S332). For example, as illustrated in FIG. 27B, with the object 7 being placed, an object image 8B is acquired by including both the object 7 and the background in the field of view and photographing the object 7 and the background by using the camera 180.

Next, the application processor 220 acquires a differential image 8C of the object 7 by subtracting a pixel value of the background image 8A from a pixel value of the object image 8B (step S333). As illustrated in FIG. 27C, the differential image 8C of the object 7 is acquired by subtracting the pixel value of the background image 8A from the pixel value of the object image 8B.

Next, the application processor 220 acquires an image 8D of a specific region by binarizing the differential image 8C (step S334). As illustrated in FIG. 27D, in the image 8D of the specific region, a display region 8D1 (white region) of the object 7 has the value “1.” A region 8D2 (black region) other than the display region 8D1 of the object 7 has the value “0.” The display region 8D1 is the specific region.

When the differential image 8C is binarized, a threshold that is as close to “0” as possible may be used so that the image 8C is divided into the display region 8D1, which has a pixel value, and the region 8D2, which does not have a pixel value.

By performing the above-described processing, a specific region may be obtained.

### Fourth Embodiment

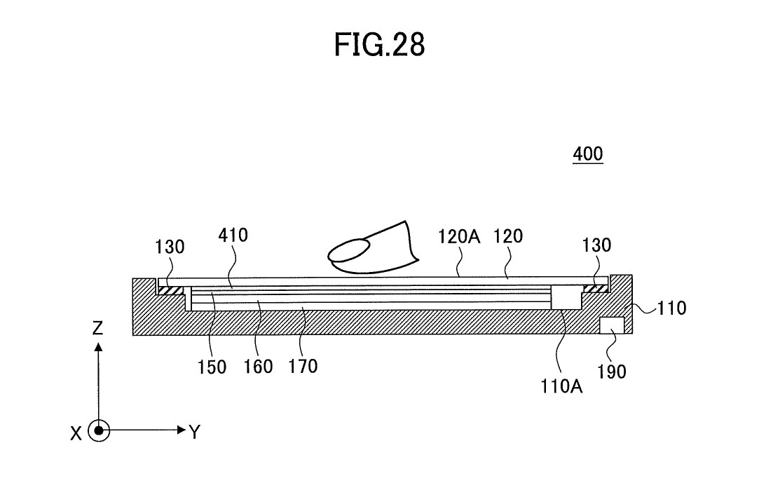

FIG. 28 is a side view illustrating an electronic device 400 of a fourth embodiment. The side view illustrated in FIG. 28 corresponds to the side view illustrated in FIG. 3.

The electronic device 400 of the fourth embodiment provides a tactile sensation by using a transparent electrode plate 410 disposed between the top panel 120 and the touch panel 150, instead of providing a tactile sensation by using the vibrating element 140 as with the electronic device 100 of the first embodiment. Further, a surface opposite to the surface 120A of the top panel 120 is an insulating surface. If the top panel 120 is a glass plate, an insulation coating may be formed on the surface opposite to the surface 120A.

When a voltage is applied to the electrode plate 410, an electric charge is generated on the surface 120A of the top panel 120. By way of example herein, it is assumed that a negative electric charge is generated on the surface 120A of the top panel 120.

In this state, when the user moves the fingertip close to the surface 120A, a positive electric charge is induced on the fingertip. Because the negative electric charge on the surface 120A and the positive electric charge on the fingertip attract each other, an electrostatic force is generated, making a friction force applied to the fingertip increase.

In light of the above, no voltage is applied to the electrode plate 410 when a position where the user's fingertip touches the surface of the top panel 120 (the position of the manipulation input) is located in a specific region and such a position of the manipulation input is in motion. This is to decrease a friction force applied to the user's fingertip, compared to when a voltage is applied to the electrode plate 410 and an electrostatic force is generated.

On the other hand, a voltage is applied to the electrode plate 410 when the position of the manipulation input is located outside the specific region and the position of the manipulation is in motion. Generating an electrostatic force by applying a voltage to the electrode plate 410 causes a friction force applied to the user's fingertip to increase, compared to when no electrostatic force is generated.

In this way, similarly to the electronic device 100 of the first embodiment, it is possible to provide a tactile sensation based on the presence or absence of gloss.

According to at least one embodiment of the present disclosures, an electronic device and a drive controlling method are provided in which a tactile sensation based on the presence or absence of gloss can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An electronic device comprising:
an imaging part configured to acquire an image and a range image in a field of view that includes a photographic subject;
a range image extracting part configured to extract a range image of the photographic subject based on the image and the range image;
a gloss determining part configured to determine whether the photographic subject is a glossy object based on a data lacking portion included in the range image of the photographic subject;
a display part configured to display the image;
a top panel disposed on a display surface side of the display part and having a manipulation surface;
a position detector configured to detect a position of a manipulation input performed on the manipulation surface;
a vibrating element configured to be driven by a driving signal for generating a natural vibration in an ultrasound frequency band on the manipulation surface so as to generate the natural vibration in the ultrasound frequency band on the manipulation surface;
an amplitude data allocating part configured to allocate, as amplitude data of the driving signal, first amplitude to a display region of the photographic subject that has been determined to be the glossy object by the gloss determining part, and to allocate, as the amplitude data of the driving signal, second amplitude that is smaller than the first amplitude to the display region of the photographic subject that has been determined to be a non-glossy object by the gloss determining part; and
a drive controlling part configured to drive the vibrating element by using the driving signal to which the first amplitude has been allocated in accordance with a degree of time change of the position of the manipulation input, upon the manipulation input onto the manipulation surface being performed in a region where the photographic subject that has been determined to be the glossy object by the gloss determining part is displayed on the display part, and to drive the vibrating element by using the driving signal to which the second amplitude has been allocated in accordance with the degree of time change of the manipulation input, upon the manipulation input onto the manipulation surface being performed in the region where the photographic subject that has been determined to be the non-glossy object by the gloss determining part is displayed on the display part.

2. The electronic device according to claim 1, wherein the drive controlling part does not drive the vibrating element upon the manipulation input onto the manipulation surface being performed in a region other than the region where the photographic subject is displayed on the display part.

3. The electronic device according to claim 1, wherein the gloss determining part determines that the photographic subject is the glossy object in response to the data lacking portion being equal to or greater than a predetermined threshold.

4. The electronic device according to claim 1, further comprising:
a memory configured to store data that represents the first amplitude and the second amplitude,
wherein the amplitude data allocating part allocates the first amplitude and the second amplitude stored in the memory as the amplitude data.

5. The electronic device according to claim 1, wherein the amplitude data allocating part sets the first amplitude or the second amplitude based on a type of the manipulation input performed by a user.

6. The electronic device according to claim 1, wherein the second amplitude varies depending on a position in the display region of the photographic subject that has been determined to be the non-glossy object by the gloss determining part.

7. The electronic device according to claim 1, wherein the imaging part includes:
a first imaging part configured to acquire the image; and
a second imaging part configured to acquire the range image.

8. The electronic device according to claim 7, wherein the first imaging part and the second imaging part are disposed proximate to each other.

9. The electronic device according to claim 7, wherein the first imaging part is a camera configured to acquire a color image as the image.

10. The electronic device according to claim 1, wherein the imaging part is an infrared camera configured to acquire an infrared image as the image and also acquire the range image.

11. A drive controlling method for driving a vibrating element of an electronic device including,
an imaging part configured to acquire an image and a range image in a field of view that includes a photographic subject,
a range image extracting part configured to extract a range image of the photographic subject based on the image and the range image,
a gloss determining part configured to determine whether the photographic subject is a glossy object based on a data lacking portion included in the range image of the photographic subject,
a display part configured to display the image,
a top panel disposed on a display surface side of the display part and having a manipulation surface,
a position detector configured to detect a position of a manipulation input performed on the manipulation surface, and
the vibrating element configured to be driven by a driving signal for generating a natural vibration in an ultrasound frequency band on the manipulation surface so as to generate the natural vibration in the ultrasound frequency band on the manipulation surface, the method comprising:
allocating, by a computer, as amplitude data of the driving signal, first amplitude to a display region of the photographic subject that has been determined to be the glossy object by the gloss determining part, and to allocate, as the amplitude data of the driving signal, second amplitude that is smaller than the first amplitude to the display region of the photographic subject that has been determined to be a non-glossy object by the gloss determining part; and
driving the vibrating element by using the driving signal to which the first amplitude has been allocated in accordance with a degree of time change of the position of the manipulation input, upon the manipulation input onto the manipulation surface being performed in a region where the photographic subject that has been determined to be the glossy object by the gloss determining part is displayed on the display part, and driving the vibrating element by using the driving signal to which the second amplitude has been allocated in accordance with the degree of time change of the manipulation input, upon the manipulation input onto the manipulation surface being performed in the region where the photographic subject that has been determined to be the non-glossy object by the gloss determining part is displayed on the display part.
